(19) United States
(12) Patent Application Publication
(10) Pub. No.: US 2026/0261586 A1
(43) Pub. Date: Sep. 3, 2026

(54) INFORMATION TRANSMISSION METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Jinhua WU, Beijing (CN); Jianning LIU, Beijing (CN); Yang SHEN, Beijing (CN); Nan ZHANG, Beijing (CN); Yuxin MAO, Beijing (CN)

(21) Appl. No.: 18/876,063

(22) PCT Filed: Jun. 21, 2022
(86) PCT No.: PCT/CN2022/100241

§ 371 Date: Dec. 17, 2024

(51) Int. Cl. H04L 65/1069; H04L 69/322

(52) U.S. Cl. CPC H04L 65/1069; H04L 69/322

(57) ABSTRACT

An information transmission method is performed by a session management function (SMF), and includes: sending UE status information of a user equipment (UE) to an access network function, wherein the UE status information is used for the access network function to determine at least one of a service data stream transmission of the UE, or a quality of service (QoS) parameter of the service data stream transmission.

### CROSS-REFERENCE TO RELATED APPLICATION

The present application is a U.S. National Stage of International Application No. PCT/CN2022/100241, filed on Jun. 21, 2022, the entire content of which is incorporated herein by reference.

### TECHNICAL FIELD

The present disclosure relates to, but is not limited to, the field of the communication technology, and in particular relates to an information transmission method and apparatus, a communication device, and a storage medium.

### BACKGROUND

Currently, the fifth generation cellular mobile communication system (5GS) adopts a generic quality of service (QoS) S mechanism to process various types of data services including extended reality (XR) services and/or media services.

### SUMMARY

Embodiments of the present disclosure disclose an information transmission method and apparatus, a communication device, and a storage medium.

According to a first aspect of the present disclosure, there is provided an information transmission method, performed by a session management function (SMF), including:
sending UE status information of a user equipment (UE) to an access network function, where the UE status information is used for the access network function to determine a service data stream transmission of the UE and/or a quality of service (QoS) parameter of the service data stream transmission.

According to a second aspect of the present disclosure, there is provided an information transmission method, performed by a UDM, including:
sending UE status information of a UE to an SMF, where the UE status information is used for being sent by the SMF to an access network function for the access network function to determine a service data stream transmission of the UE and/or a QoS parameter of the service data stream transmission.

According to a third aspect of the present disclosure, there is provided an information transmission method, performed by an access network function, including:
receiving UE status information of a UE sent by a core network, where the UE status information is used for the access network function to determine a service data stream transmission of the UE and/or a QoS parameter of the service data stream transmission.

According to a fourth aspect of the present disclosure, there is provided an information transmission method, performed by a UE, including:
sending UE status information of the UE to a core network, where the UE status information is used for being sent by the core network to an access network function for the access network function to determine a service data stream transmission of the UE and/or a QoS parameter of the service data stream transmission.

According to a fifth aspect of the present disclosure, there is provided a communication device, where the communication device includes:
a processor; and
a memory, configured to store an executable instruction of the processor; where
the processor, when running the executable instruction, is configured to implement the information transmission method according to the first, second or third aspect.

According to a sixth aspect of the present disclosure, there is provided a computer storage medium, where the computer storage medium stores an executable program of a computer, and the executable program, when executed by a processor, implements the information transmission method according to the first, second or third aspect.

It should be understood that the above general description and the later detailed description are only exemplary and explanatory, and do not limit the embodiments of the present disclosure.

### BRIEF DESCRIPTION OF THE DRAWINGS

FIG. 1 is a schematic structural diagram of a wireless communication system according to an exemplary embodiment.

FIG. 2 is a schematic flow diagram of an information transmission method according to an exemplary embodiment.

FIG. 3 is a schematic flow diagram of an information transmission method according to an exemplary embodiment.

FIG. 4 is a schematic flow diagram of an information transmission method according to an exemplary embodiment.

FIG. 5 is a schematic flow diagram of an information transmission method according to an exemplary embodiment.

FIG. 6 is a schematic flow diagram of an information transmission method according to an exemplary embodiment.

FIG. 7 is a schematic flow diagram of an information transmission method according to an exemplary embodiment.

FIG. 8 is a schematic flow diagram of an information transmission method according to an exemplary embodiment.

FIG. 9 is a schematic flow diagram of an information transmission method according to an exemplary embodiment.

FIG. 10 is a schematic flow diagram of an information transmission method according to an exemplary embodiment.

FIG. 11 is a schematic flow diagram of an information transmission method according to an exemplary embodiment.

FIG. 12 is a block diagram of an information transmission apparatus according to an exemplary embodiment.

FIG. 13 is a block diagram of an information transmission apparatus according to an exemplary embodiment.

FIG. 14 is a block diagram of an information transmission apparatus according to an exemplary embodiment.

FIG. 15 is a block diagram of an information transmission apparatus according to an exemplary embodiment.

FIG. 16 is a block diagram of a UE according to an exemplary embodiment.

FIG. 17 is a block diagram of a base station according to an exemplary embodiment illustrated.

### DETAILED DESCRIPTION

The exemplary embodiments are described in detail here, examples of which are indicated in the accompanying drawings. When the following description involves the accompanying drawings, the same numerals in different accompanying drawings indicate the same or similar elements unless otherwise indicated. The embodiments described in the following exemplary embodiments do not represent all embodiments consistent with the embodiments of the present disclosure. On the contrary, they are only examples of devices and methods consistent with some aspects of the embodiments of the present disclosure as detailed in the appended claims.

The terms used in the embodiments of the present disclosure are used solely for the purpose of describing particular embodiments, but are not intended to limit the embodiments of the present disclosure. The singular forms of “a” and “the” used in the embodiments of the present disclosure and the appended claims are also intended to include the plural form, unless the context clearly indicates other meanings. It should also be understood that the term “and/or” as used in this article refers to and includes any or all possible combinations of one or more of the associated listed items.

It should be understood that although the terms first, second, third, etc. may be used in the embodiments of the present disclosure to describe various types of information, such information should not be limited to these terms. These terms are only used to distinguish the same type of information from one another. For example, without departing from the scope of the embodiments of the present disclosure, the first information may also be referred to as the second information, and similarly, the second information may also be referred to as the first information. Depending on the context, the phrase “if” as used herein may be interpreted as “at the time of . . . ”, “when . . . ”, or “in response to determining”.

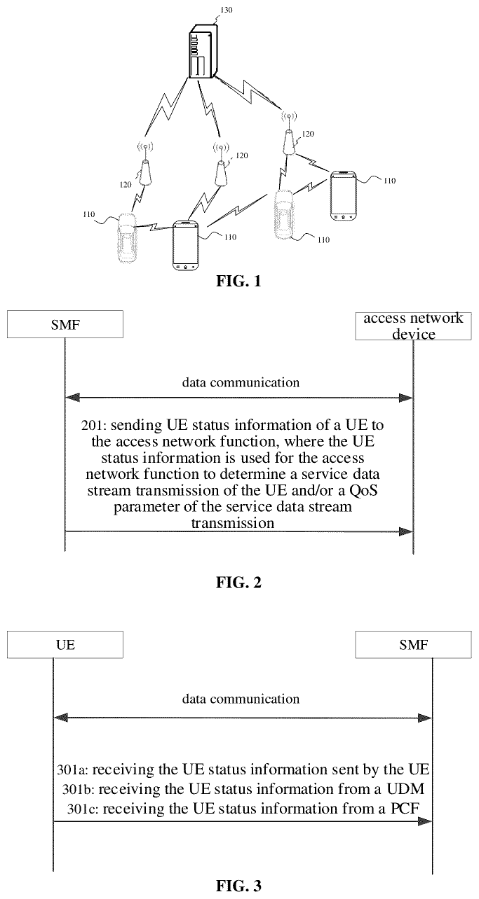

Referring to FIG. 1, a schematic structural diagram of a wireless communication system provided in an embodiment of the present disclosure is shown. As shown in FIG. 1, the wireless communication system is a communication system based on the cellular mobile communication technology, and the wireless communication system may include one or more UEs 110, and one or more base stations 120.

In some embodiments, the UE 110 may refer to a device that provides voice and/or data connectivity to a user. The UE 110 may communicate with one or more core networks via a radio access network (RAN). The UE 110 may be an IoT (internet of things) UE, such as a sensor device, a mobile phone (or referred to as a “cellular” phone), or a computer with an IoT UE. For example, the UE 110 may be a fixed, portable, pocket, handheld, computer built-in, or vehicle-mounted device. For example, the UE 110 may be a station (STA), a subscriber unit, a subscriber station, a mobile station, a mobile, a remote station, an access point, a remote UE (remote terminal), an access UE (access terminal), a user device (user terminal), a user agent, a user device, or a user equipment. Or, the UE 110 may be a device of an unmanned aerial vehicle. Or, the UE 110 may be a vehicle-mounted device, such as a trip computer with wireless communication functions, or a wireless UE externally connected to a trip computer. Or, the UE 110 may be a road side device, such as a street light, a signal light, or other road side devices with wireless communication functions.

The base station 120 may be a network side device in the wireless communication system. In some embodiments, the wireless communication system may be the 4th generation mobile communication (4G) system, also referred to as the long term evolution (LTE) system. Or, the wireless communication system may be a 5G system, also referred to as a new radio (NR) system or a 5G NR system. Or, the wireless communication system may be a next generation system of the 5G system. In some embodiments, the access network in the 5G system may be referred to as a new generation-radio access network (NG-RAN).

In some embodiments, the base station 120 may be an evolved base station (eNB) used in a 4G system. Or, the base station 120 may be a base station (gNB) with a centralized distributed architecture in a 5G system. When adopting the centralized distributed architecture, the base station 120 typically includes a central unit (CU) and at least two distributed units (DUs). The central unit is provided with a protocol stack of a packet data convergence protocol (PDCP) layer, a radio link control (RLC) layer, and a medium access control (MAC) layer. The distributed unit is provided with a protocol stack of a physical (PHY) layer. The embodiments of the present disclosure do not limit the specific implementations of the base station 120.

A wireless connection may be established between the base station 120 and the UE 110 via a wireless air interface. In a different embodiment, the wireless air interface is a wireless air interface based on a 4G standard. Or, the wireless air interface is a wireless air interface based on a 5G standard, for example, the wireless air interface is a new air interface. Or, the wireless air interface may also be a wireless air interface based on a next generation mobile communication network technology standard of the 5G.

In some embodiments, an end to end (E2E) connection may also be established between UEs 110, for example, scenarios such as vehicle to vehicle (V2V) communications, vehicle to infrastructure (V2I) communications, and vehicle to pedestrian (V2P) communications in the vehicle to everything (V2X) communications.

Here, the above-described UE may be considered as the terminal device of the following embodiments.

In some embodiments, the above-described wireless communication system may further include a network management device 130.

One or more base stations 120 are connected to the network management device 130 respectively. In some embodiments, the network management device 130 may be a core network device in the wireless communication system, for example, the network management device 130 may be a mobility management entity (MME) in the evolved packet core (EPC). Alternatively, the network management device may also be other core network devices, such as a service gateway (SGW), a public data network gateway (PGW), a policy and charging rules function (PCRF), or a home subscriber server (HSS). The implementation forms of the network management device 130 are not limited in the embodiments of the present disclosure.

In order to facilitate the understanding of those skilled in the art, the embodiments of the present disclosure enumerate a plurality of embodiments to provide a clear description of the technical solutions of the embodiments of the present disclosure. Of course, those skilled in the art can understand that the plurality of embodiments provided by the embodiments of the present disclosure may be performed individually or in combination with the methods of other embodiments in the embodiments of the present disclosure, or may be performed individually or in combination with some methods of other related arts. The embodiments of the present disclosure do not limit this.

Currently, the fifth generation cellular mobile communication system (5GS) adopts a generic quality of service (QoS) S mechanism to process various types of data services including extended reality (XR) services and/or media services, which does not adequately take into account the characteristics of the XR services and/or media services, and is not capable of supporting effectively the differentiated uplink and downlink requirements, such as asymmetric requirements for uplink data reliability and downlink data bandwidth. Meanwhile, XR media data streams have the characteristics of high bandwidth, low latency and high reliability requirements, resulting in outstanding energy consumption. The energy consumption scheme is also an important factor affecting service usage and user experience. XR services and/or media services require higher throughput and lower latency, consume more power, and consume more network resources. Therefore, the trade-off between the QoS and the device power consumption needs to be considered. Currently, there is no corresponding QoS and policy mechanism to satisfy the above set of requirements.

Therefore, how to balance the UE energy consumption and the transmission performance of XR services/media services, e.g., balancing the battery duration of the UE and the throughput, latency, and reliability, etc. of data services is an urgent problem to be solved.

As shown in FIG. 2, the embodiments of the present disclosure provide an information transmission method, performed by an SMF, including step 201.

At step 201, UE status information of a UE is sent to an access network function, where the UE status information is used for the access network function to determine a service data stream transmission of the UE and/or a QoS parameter of the service data stream transmission.

The UE status information may be used for indicating a status of the UE. The status of the UE may include, but is not limited to, at least one of the following: a load state of the UE, a battery state of the UE, a temperature state of the UE, a power consumption state of the UE, etc.

The UE status information may be used for determining, by the access network function, the service data stream transmission and/or the QoS parameter of the service data stream transmission. Here, the access network function may be implemented by an access network device such as a base station.

In an embodiment, determining the service data stream transmission by the access network function includes: determining, by the access network function, whether the service data stream transmission is to be performed.

There may be one or more service data streams. The access network function may determine one or more service data streams for transmission.

Here, the QoS parameter includes, but is not limited to, at least one of the following: (1) a QoS class identifier (QCI), an allocation and retention priority (ARP), a guaranteed bit rate (GBR), a maximum bit rate (MBR), an aggregated maximum bit rate (AMBR). Here, the QoS may be specific to the service data stream.

Here, different QoS parameters may be set for different statuses of the UE. For example, different QoS parameters may be set for different battery power levels of the UE. For example, a QoS parameter with low energy consumption may be configured for a power level with a low battery power of the UE.

In an embodiment, the service data stream transmission and/or the QoS parameter of the service data stream transmission may have an impact on the status of the UE.

In an embodiment, the UE status information is at least used for indicating at least one of the following:
a battery power of the UE;
a battery usage duration of the UE;
a power supply mode of the UE;
a temperature status of the UE.

The battery power of the UE may be indicated by a battery power level. For example, from 0% to 100%, the battery power may be divided into a plurality of battery power levels, with different battery power levels indicating different battery power ranges.

The battery usage duration of the UE may include at least one of the following: a usage duration of the remaining battery power, a duration during which the battery has been used, etc.

The power supply mode of the UE may include at least one of the following: a battery powered mode, an external powered mode (e.g., powered by the mains power supply), a hybrid powered mode (powered by the battery combined with the mains power supply, etc.).

The temperature status of the UE may include temperatures of one or more of different temperature measurement points of the UE. For example, the temperature status of the UE may include at least one of the following: a temperature status of the processor of the UE, a temperature status of the battery of the UE.

In an embodiment, the temperature status of the UE is indicated by using a battery temperature level. For example, the temperature status of the UE may be indicated by using three temperature levels, i.e., a high temperature level, a medium temperature level and a low temperature level.

In an embodiment, the service data stream of the UE includes at least one of the following:
an XR type service data stream of the UE;
a multimodal data service data stream of the UE.

The XR type service data stream generally has characteristics of high bandwidth, low latency and high reliability requirements, thus leading to outstanding energy consumption of the UE. Here, the service has a strong correlation with the status of the UE as indicated by the UE status information.

The multimodal data service data stream is used for transmitting data in different modalities, and therefore also has the characteristics of high bandwidth, low latency and high reliability requirements, thus leading to outstanding energy consumption of the UE. Here, the service has a strong correlation with the status of the UE as indicated by the UE status information.

For example, the XR type service data stream consumes a significant amount of battery power, and increases the temperature of the UE, and the like.

Here, the access network function, etc., may determine, based on the UE status information, the service data stream that is allowed and/or disallowed to be transmitted, and the QoS parameter of the transmitted service data stream.

In an embodiment, the access network function may determine the service data stream transmission that satisfies the status of the UE indicated by the UE status information, and/or the QoS parameter of the service data stream transmission.

For example, when the battery power of the UE is low, or the temperature of the UE is high, the service data stream transmission may be reduced, enabling the energy consumption of the service data stream transmission to be reduced, thereby increasing the power supply duration of the battery, and reducing the temperature of the UE.

When the battery power of the UE is low, or the temperature of the UE is high, the QoS parameter may be adjusted to reduce the transmission bandwidth, etc., enabling the energy consumption of the service data stream transmission to be reduced, thereby increasing the power supply duration of the battery, and reducing the temperature of the UE.

As another example, when the UE is powered by the mains power supply, and the temperature of the UE is low, the QoS parameter may be adjusted to increase the transmission bandwidth, and reduce the transmission latency, etc., thereby improving the user experience.

Here, the UE status information may be sent by a core network element SMF to the access network function. The UE status information is not sent from the UE directly to the access network function. This can reduce the impact on the air interface data transmission due to the UE sending the UE status information directly to the access network function, and improves compatibility.

In an embodiment, the UE status information is sent by the UE to the core network through an NAS message.

The UE may determine its own UE status and send it to the core network through the UE status information. The UE status information may be carried in the NAS message to be sent to the core network, e.g., to the AMF, SMF, PCF, and/or UMD. Then, the UE status information is sent to the access network function by the core network element such as the SMF.

In this way, the UE status information of the UE is sent to the access network function by the SMF, and the access network function determines, based on the UE status information, the service data stream transmission of the UE and/or the QoS parameter of the service data stream transmission. On the one hand, the UE status such as energy consumption of the UE, and the transmission performance of the service data stream such as the XR media service is balanced. On the other hand, sending the UE status information to the access network function through the SMF can reduce the impact on the air interface data transmission due to the UE sending the UE status information directly to the access network function, and improves compatibility.

As shown in FIG. 3, the embodiments of the present disclosure provide an information transmission method, performed by an SMF, including at least one of the following steps 301a, 301b and 301c.

At step 301a, the UE status information sent by the UE is received.

At step 301b, the UE status information from a UDM is received.

At step 301c, the UE status information from a PCF is received.

Step 301a and/or step 301b and/or step 301c may be implemented individually, or in combination with step 201.

In an embodiment, the UE status information may be sent by the UE to the SMF. For example, the UE status information may be carried in the NAS to be sent to the SMF.

In an embodiment, the UE status information may be sent by the UE to the core network element in advance, and stored in the UDM.

In an embodiment, the UE status information may be sent by the UE to the core network element in advance, and stored in the PCF.

In an embodiment, the UE status information may be sent by an application of the UE to the AF of the core network, and sent by the AF to the NEF, and then stored by the NEF in the UDM.

In an embodiment, the UE status information may be associated with a validity duration. The validity duration may be stored in the UDM/UDR and the NF. The UDM may provide the UE status information to the core network element (e.g., the AMF and/or the SMF) within the validity duration. At the expiration of the validity period, each node automatically deletes the UE status information. The UDM may delete the UE status information without an explicit signaling.

In an embodiment, the UDM may pre-authorize the AF and/or the NEF to transmit the UE status information. For example, the UDM may pre-authorize the AF and/or the NEF to transmit a communication signaling carrying the UE status information.

The SMF may obtain the UE status information from the UDM through subscribing, etc. The SMF may also obtain the UE status information from the UDM through retrieving at the UDM, etc.

In an embodiment, the UE status information may be sent by the application of the UE to the AF of the core network, and sent by the AF to the NEF, and then stored by the NEF in the UDM.

In an embodiment, the UE status information may be sent by the UE to the PCF.

In an embodiment, the UE status information may be sent by the application of the UE to the AF of the core network, and sent by the AF to the PCF. Here, the AF may be a trusted AF.

In an embodiment, the UE status information may be sent by the application of the UE to the AF of the core network, and sent by the AF to the NEF, and then stored by the NEF in the PCF.

The PCF may send, based on subscription information of the SMF, etc., the UE status information to the SMF.

In an embodiment, the PCF may send, based on the subscription information of the SMF, etc., the UE status information to the SMF.

In an embodiment, the SMF retrieves the UE status information in the PCF.

In an embodiment, receiving the UE status information from the UDM includes:
receiving, from the UDM, an expected UE behaviour parameter carrying the UE status information.

In an embodiment, what the NEF sends to the UDM may be separate UE status information. The UDM may store the separate UE status information.

In an embodiment, what the NEF sends to the UDM may be the expected UE behaviour parameter, and the UE status information may be part of the expected UE behaviour parameter. The UDM may store the expected UE behaviour parameter, where the expected UE behaviour parameter may include the UE status information.

The UE status information stored by the UDM may be identified by using identification information of the UE. Here, the identification information of the UE includes, but is not limited to, a SUPI.

In an embodiment, the expected UE behaviour parameter characterizes the expected behaviour of a UE or a group of UEs. A set of these UE behaviour parameters may be provided through the NEF for storage as part of the UE data.

In an embodiment, the SMF retrieves from the UDM the expected UE behaviour parameter associated with the SMF for a particular PDU session.

The details of the expected UE behaviour parameter may be as shown in Table 1. The UE status information in the expected UE behaviour parameter may include at least one of the following: a power supply mode, a UE temperature, an overheating status, a battery power of the UE, a battery indication.

TABLE 1

| Expected UE | |
|---|---|
| Behaviour Parameter | Description |
| Power Supply Mode | Identifying the current power supply mode of |
| (Powered Mode) | the UE, for example, battery powered mode, |
| | or mains/wall powered mode |
| UE Temperature, | Identifying the current heat state of the UE, |
| UE Overheating Status | for example, high, medium, and low |
| Battery Power of UE | Identifying the current battery power level of |
| | the UE, for example, |
| | when the battery power exceeds 80%, |
| | maintaining a high screen refresh rate for all |
| | services; |
| | when the battery power is below 80%, |
| | maintaining a medium screen refresh rate for |
| | all services; |
| | when the battery power is below 20%, |
| | turning off some non-mandatory and high |
| | power consumption threads or applications; |
| | when the battery power is below 10%, |
| | turning off or disabling all non-mandatory or |
| | high power consumption threads or |
| | applications; |
| Battery Indication | Identifying the importance of the power |
| | consumption of the UE: whether the UE is |
| | powered by a non-rechargeable/non- |
| | replaceable battery, is powered by a |
| | rechargeable/replaceable battery, or is |
| | powered by a non-battery |
| | [Optional] |

In an embodiment, receiving the UE status information from the UDM includes:
receiving, from the UDM, the UE status information stored by the UDM for the SMF.

Upon receiving the UE status information, the UDM may store the UE status information as differently categorized UE status information for reading by different network elements. For example, the UDM may store the UE status information as UE status information for reading by the AMF, and UE status information for reading by the SMF. The UE status information may be stored in information associated with the AMF, and/or the UE status information may be stored in information associated with the SMF.

In an embodiment, the UE status information for reading by the AMF is specific to the UE, and the UE status information for reading by the SMF may be specific to the PDU session of the UE.

The UE status information stored for the AMF may be used for the access network function to determine a transmission parameter of a predetermined data service of the UE.

The UE status information stored for the SMF may be used for the access network function to determine a transmission parameter of a predetermined data service in a particular PDU session of the UE, such as a PDU session corresponding to a PDU session establishment request.

In an embodiment, the UE status information from the UDM is subscribed by the SMF to the UDM.

The SMF may pre-subscribe the UE status information (including: the expected UE behaviour parameter containing the UE status information), and the UDM, upon receiving the UE status information, may notify, through a notification message (e.g., Nudm_SDM_Notification), the subscriber (AMF, SMF, etc.) of the UE status information of the update to the UE status information. The UE status information may be carried in the notification message. The AMF and/or SMF, etc. may obtain the UE status information.

In an embodiment, the UE status information may be identified by using the identification information of the UE.

In an embodiment, the UE status information may be identified by using the DNN/S-NSSAI for association with the PDU session.

For example, the UE status information is carried in the expected UE behaviour parameter. The UDM performs the Nudm_SDM_Notification (the SUPI or internal group identifier, the expected UE behaviour parameter set associated with the SMF, the DNN/S-NSSAI, the suggested number of downlinked data packet, etc.) service operation.

The SMF stores the expected UE behaviour parameter (including the UE status information) as received, and associates, based on the DNN and S-NSSAI included in the message from the UDM, the expected UE behaviour parameter with the PDU session.

The SMF identifies if there are overlapped parameter sets in the expected UE behaviour, and merges the parameter sets if necessary. The SMF may use the following parameters.

The SMF may export, for the PDU session, SMF exported CN-assisted RAN information. For example, in the PDU session establishment process or the PDU session modification process, the SMF provides the SMF exported CN-assisted RAN information to the AMF.

In an embodiment, receiving the UE status information sent by the UE includes:
receiving an SM context establishment request sent by an AMF to the SMF, where the SM context establishment request carries the UE status information, and the SM context establishment request is sent by the AMF upon receiving a PDU session establishment request carrying the UE status information.

The UE may send the UE status information to the SMF during the PDU session establishment process after the UE completes registration.

The UE may carry the UE status information in the PDU session establishment request. The AMF may send the SM context establishment request to the SMF after receiving the PDU session establishment request.

In an embodiment, the UE status information may be carried in an N1 SM container of the PDU session establishment request. In response to the PDU session establishment request carrying the UE status information, the AMF may send the UE status information to the SMF.

The AMF obtains the UE status information by reading the N1 SM container.

In an embodiment, the AMF may store the UE status information in the context of the UE.

The AMF may send, by carrying the UE status information in the SM context establishment request, the UE status information to the SMF.

In an embodiment, the UE status information may be carried in the N1 SM container of the SM context establishment request. The SMF obtains the UE status information by reading the N1 SM container.

During the PDU session establishment process, the AMF, upon receiving the PDU session establishment request, may select the SMF used for the PDU session, and sends the SM context establishment request to the selected SMF. The AMF may carry the UE status information in the SM context establishment request.

In an embodiment, the UE status information is carried in at least one of the following:
a PCO in the PDU session establishment request;
UE session management core network capability information in the PDU session establishment request.

If the UE sends the UE status information to the AMF through the PDU session establishment request, the UE status information may be carried in the PCO and/or the UE 5G session management core network capability (UE 5G SM core network capability) information in the PDU session establishment request.

In an embodiment, the UE status information may be carried in the PCO and/or the UE 5G SM core network capability information of the N1 SM container in the SM context establishment request.

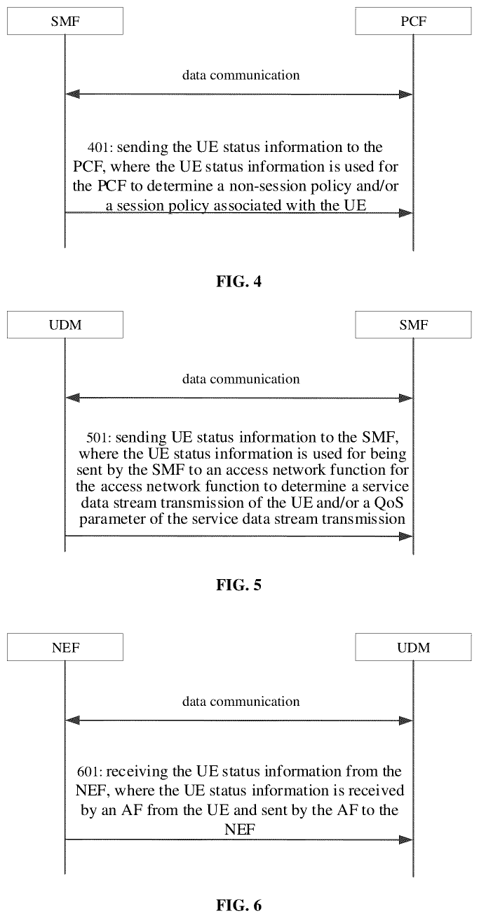

As shown in FIG. 4, the embodiments of the present disclosure provide an information transmission method, performed by an SMF, including step 401.

At step 401, the UE status information is sent to the PCF, where the UE status information is used for the PCF to determine a non-session policy and/or a session policy associated with the UE.

If the SMF determines, during the PDU session establishment process, that the PDU session uses the dynamic PCC, the SMF performs PCF selection. Based on the contracting and the application information provided by the AF, the PCF may generate/activate a rule for the corresponding service data stream, e.g., an XR type service rule/multimodal service rule, or generate/activate a data stream PCC rule that enhances the support of the data service (e.g., the XR type service and multimodal service session). (For example, associating the XRM service data stream, matching the XRM service and multimodal service QoS, including the GFBR, PDB, MDBV matching of the XRM and multimodal service data stream, etc.)

The SMF reports the UE status information to the PCF. The reporting condition of the SMF may include, but is not limited to, at least one of the following: the PCF subscribing the UE status change event and the reporting condition being satisfied, or the contracted information or local policy triggering the reporting of the UE status information. According to the subscription and reporting requirement, the UE status information notify reporting is performed.

The PCF formulated policy and charging control policy include two categories: session related policies and non-session related policies. In some embodiments, the non-session related policies include a UE policy provided to the UE, an access and mobility management policy and an SMF selection policy provided to the AMF. The session related policies are mainly provided to the SMF, including a charging policy, a gating and QoS control policy, a usage monitoring policy, an application detection policy, and a session related network capability exposure policy, etc.

The PCF may determine, based on the UE status information as received, the non-session UE policy and/or session policy of the UE. The PCF may set, for different UE statuses, different non-session policies and/or session policies of the UE. The PCF issues the updated non-session policy and/or session policy to the AF and the UE.

For example, when the battery power of the UE is low, or the temperature of the UE is high, the non-session policy and/or session policy may be adjusted to reduce the transmission bandwidth, etc., enabling the energy consumption of the data service to be reduced, thereby increasing the power supply duration of the battery, and reducing the temperature of the UE.

As another example, when the UE is powered by the mains power supply, and the temperature of the UE is low, the non-session policy and/or session policy may be adjusted to increase the transmission bandwidth, and reduce the transmission latency, etc., thereby improving the user experience.

In this way, the PCF sets, based on the UE status information, the non-session policy and/or the session policy of the UE to balance the UE status such as energy consumption of the UE, and the transmission performance of the UE.

In an embodiment, sending the UE status information of the UE to the access network function includes:
sending an N2 session message carrying the UE status information to an AMF, where the UE status information is sent to the access network function by the AMF through carrying the UE status information in an N2 message and/or an NGAP signaling.

The SMF may send the UE status information to the AMF through N2 SM information, and the UE status information is forwarded by the AMF to the access network function for the access network function to perform QoS mapping and transmission of uplink or downlink data streams to better match the XR type service or multimodal service traffic characteristic and energy consumption management. The AMF may send the UE status information to the access network function in the N2 message. The AMF may also send the UE status information to the access network function by using the NGAP signaling.

As shown in FIG. 5, the embodiments of the present disclosure provide an information transmission method, performed by a UDM, including step 501.

At step 501, UE status information is sent to an SMF, where the UE status information is used for being sent by the SMF to an access network function for the access network function to determine a service data stream transmission of the UE and/or a QoS parameter of the service data stream transmission.

The UE status information may be used for indicating a status of the UE. The status of the UE may include, but is not limited to, at least one of the following: a load state of the UE, a battery state of the UE, a temperature state of the UE, a power consumption state of the UE, etc.

The UE status information may be used for determining, by the access network function, the service data stream transmission and/or the QoS parameter of the service data stream transmission. Here, the access network function may be implemented by an access network device such as a base station.

In an embodiment, determining the service data stream transmission by the access network function includes: determining, by the access network function, whether the service data stream transmission is to be performed.

There may be one or more service data streams. The access network function may determine one or more service data streams for transmission.

Here, the QoS parameter includes, but is not limited to, at least one of the following: (1) a QoS class identifier (QCI), an allocation and retention priority (ARP), a guaranteed bit rate (GBR), a maximum bit rate (MBR), an aggregated maximum bit rate (AMBR). Here, the QoS may be specific to the service data stream.

Here, different QoS parameters may be set for different statuses of the UE. For example, different QoS parameters may be set for different battery power levels of the UE. For example, a QoS parameter with low energy consumption may be configured for a power level with a low battery power of the UE.

In an embodiment, the service data stream transmission and/or the QoS parameter of the service data stream transmission may have an impact on the status of the UE.

In an embodiment, the UE status information is at least used for indicating at least one of the following:
a battery power of the UE;
a battery usage duration of the UE;
a power supply mode of the UE;
a temperature status of the UE.

The battery power of the UE may be indicated by a battery power level. For example, from 0% to 100%, the battery power may be divided into a plurality of battery power levels, with different battery power levels indicating different battery power ranges.

The battery usage duration of the UE may include at least one of the following: a usage duration of the remaining battery power, a duration during which the battery has been used, etc.

The power supply mode of the UE may include at least one of the following: a battery powered mode, an external powered mode (e.g., powered by the mains power supply), a hybrid powered mode (powered by the battery combined with the mains power supply, etc.).

The temperature status of the UE may include temperatures of one or more of different temperature measurement points of the UE. For example, the temperature status of the UE may include at least one of the following: a temperature status of the processor of the UE, a temperature status of the battery of the UE.

In an embodiment, the temperature status of the UE is indicated by using a battery temperature level. For example, the temperature status of the UE may be indicated by using three temperature levels, i.e., a high temperature level, a medium temperature level and a low temperature level.

In an embodiment, the service data stream of the UE includes at least one of the following:
an XR type service data stream of the UE;
a multimodal data service data stream of the UE.

The XR type service data stream generally has characteristics of high bandwidth, low latency and high reliability requirements, thus leading to outstanding energy consumption of the UE. Here, the service has a strong correlation with the status of the UE as indicated by the UE status information.

The multimodal data service data stream is used for transmitting data in different modalities, and therefore also has the characteristics of high bandwidth, low latency and high reliability requirements, thus leading to outstanding energy consumption of the UE. Here, the service has a strong correlation with the status of the UE as indicated by the UE status information.

For example, the XR type service data stream consumes a significant amount of battery power, and increases the temperature of the UE, and the like.

Here, the access network function, etc., may determine, based on the UE status information, the service data stream that is allowed and/or disallowed to be transmitted, and the QoS parameter of the transmitted service data stream.

In an embodiment, the access network function may determine the service data stream transmission that satisfies the status of the UE indicated by the UE status information, and/or the QoS parameter of the service data stream transmission.

For example, when the battery power of the UE is low, or the temperature of the UE is high, the service data stream transmission may be reduced, enabling the energy consumption of the service data stream transmission to be reduced, thereby increasing the power supply duration of the battery, and reducing the temperature of the UE.

When the battery power of the UE is low, or the temperature of the UE is high, the QoS parameter may be adjusted to reduce the transmission bandwidth, etc., enabling the energy consumption of the service data stream transmission to be reduced, thereby increasing the power supply duration of the battery, and reducing the temperature of the UE.

As another example, when the UE is powered by the mains power supply, and the temperature of the UE is low, the QoS parameter may be adjusted to increase the transmission bandwidth, and reduce the transmission latency, etc., thereby improving the user experience.

The UDM may store the UE status information, and update the UE status information.

In an embodiment, the UE status information stored by the UDM may be sent by the UE to the UDM.

For example, an application of the UE may send the UE status information to the UDM via the AF and NEF.

The UE may determine its own UE status and send the UE status information to the UDM. Then, the UE status information is sent by the UDM to the access network function via the AMF and the like.

Here, the UE status information may be sent by the UDM to the core network function such as the SMF. The SMF sends the UE status information to the access network function, and the UE status information is not directly sent to the access network function by the UE. This can reduce the impact on the air interface data transmission due to the UE sending the UE status information directly to the access network function, and improves compatibility.

In this way, the UDM sends the UE status information of the UE to the access network function via the NF, and the access network function determines, based on the UE status information, the transmission parameter of the UE. On the one hand, the UE status such as energy consumption of the UE, and the transmission performance of the data service such as the XR media service is balanced. On the other hand, sending the UE status information to the access network function through the SMF can reduce the impact on the air interface data transmission due to the UE sending the UE status information directly to the access network function, and improves compatibility.

As shown in FIG. 6, the embodiments of the present disclosure provide an information transmission method, performed by a UDM, including step 601.

At step 601, the UE status information from the NEF is received, where the UE status information is received by the AF from the UE and sent to the NEF.

Step 601 may be implemented individually or in combination with step 501.

In an embodiment, the UE status information may be associated with a validity duration. The validity duration may be stored in the UDM/UDR and the NF. The UDM may provide the UE status information to the core network element (e.g., the AMF) within the validity duration. At the expiration of the validity period, each node automatically deletes the UE status information. The UDM may delete the UE status information without an explicit signaling.

In an embodiment, the UDM may pre-authorize the AF and/or the NEF to transmit the UE status information. For example, the UDM may pre-authorize the AF and/or the NEF to transmit a communication signaling carrying the UE status information.

The SMF may obtain the UE status information from the UDM through subscribing, etc. The SMF may also obtain the UE status information from the UDM through retrieving at the UDM, etc.

In an embodiment, receiving the UE status information from the NEF includes:
receiving, from the NEF, an expected UE behaviour parameter carrying the UE status information.

In an embodiment, what the NEF sends to the UDM may be separate UE status information. The UDM may store the separate UE status information.

In an embodiment, what the NEF sends to the UDM may be the expected UE behaviour parameter, and the UE status information may be part of the expected UE behaviour parameter. The UDM may store the expected UE behaviour parameter, where the expected UE behaviour parameter may include the UE status information.

The UE status information stored by the UDM may be identified by using identification information of the UE. Here, the identification information of the UE includes, but is not limited to, a SUPI.

In an embodiment, the expected UE behaviour parameter characterizes the expected behaviour of a UE or a group of UEs. A set of these UE behaviour parameters may be provided through the NEF for storage as part of the UE data.

In an embodiment, the SMF retrieves from the UDM the expected UE behaviour parameter associated with the SMF for a particular PDU session.

The details of the expected UE behaviour parameter may be as shown in Table 1. The UE status information in the expected UE behaviour parameter may include at least one of the following: a power supply mode, a UE temperature, an overheating status, a battery power of the UE, a battery indication.

In an embodiment, sending the UE status information to the SMF includes:
sending, to the SMF, the expected UE behaviour parameter carrying the UE status information.

The UDM may send the expected UE behaviour parameter carrying the UE status information to the SMF.

In an embodiment, receiving the UE status information from the NEF includes:
obtaining subscription information from a UDR; and
receiving, in response to the subscription information indicating permission to store the UE status information, the UE status information from the NEF.

The UDM may read the corresponding subscription information from the UDR through Nudr_DM_Query to validate the required update of the expected UE behaviour parameter (including the UE status information), and authorize, for the subscriber or the corresponding AF group, the change of the expected UE behaviour parameter (including the UE status information).

If the UDM authorizes the AF to provide the expected UE behaviour parameter (including the UE status information) for the subscriber, the UDM parses the GPSI as a SUPI, and through the Nudr_DM_Create/Update/Delete Request message, the UDM requests the creation, update or deletion of the provided expected UE behaviour parameter (including the UE status information) that is part of the subscription data.

If a new 5G VN group is created, the UDM may assign a unique internal group ID to the 5G VN group, and include the newly assigned internal group ID in the Nudr_DM_Create Request message. If the 5G VN group membership list is changed or the 5G VN group data is changed, the UDM updates, based on the AF/NEF request, the expected UE behaviour parameter (including the UE status information) subscribed by the UE and/or UE group.

The UDR stores the provided expected UE behaviour parameter (including the UE status information) as part of the subscription data of the UE and/or UE group, and responds with a Nudr_DM_Create/Update/Delete Response message.

If the AF is not authorized to provide the expected UE behaviour parameter, the UDM indicates the reason for the failure in the Nudm_ParameterProvision_Update Response message.

In an embodiment, the method further includes:
storing the UE status information for the SMF.

Upon receiving the UE status information, the UDM may store the UE status information as differently categorized UE status information for reading by different network elements. For example, the UDM may store the UE status information as UE status information for reading by the AMF, and UE status information for reading by the SMF. The UE status information may be stored in information associated with the AMF, and/or the UE status information may be stored in information associated with the SMF.

In an embodiment, the UE status information for reading by the AMF is specific to the UE, and the UE status information for reading by the SMF may be specific to the PDU session of the UE.

The UE status information stored for the AMF may be used for the access network function to determine a transmission parameter of a predetermined data service of the UE.

The UE status information stored for the SMF may be used for the access network function to determine a transmission parameter of a predetermined data service in a particular PDU session of the UE, such as a PDU session corresponding to a PDU session establishment request.

In an embodiment, sending the UE status information to the SMF includes: sending to the SMF the UE status information stored for the SMF.

In an embodiment, the UE status information is subscribed by the SMF to the UDM.

The SMF may pre-subscribe the UE status information (including: the expected UE behaviour parameter containing the UE status information), and the UDM, upon receiving the UE status information, may notify, through a notification message (e.g., Nudm_SDM_Notification), the subscriber (AMF, SMF, etc.) of the UE status information of the update to the UE status information. The UE status information may be carried in the notification message. The AMF and/or SMF, etc. may obtain the UE status information.

In an embodiment, the UE status information may be identified by using the identification information of the UE.

In an embodiment, the UE status information may be identified by using the DNN/S-NSSAI for association with the PDU session.

For example, the UE status information is carried in the expected UE behaviour parameter. The UDM performs the Nudm_SDM_Notification (the SUPI or internal group identifier, the expected UE behaviour parameter set associated with the SMF, the DNN/S-NSSAI, the suggested number of downlinked data packet, etc.) service operation.

The SMF stores the expected UE behaviour parameter (including the UE status information) as received, and associates, based on the DNN and S-NSSAI included in the message from the UDM, the expected UE behaviour parameter with the PDU session.

The SMF identifies if there are overlapped parameter sets in the expected UE behaviour, and merges the parameter sets if necessary. The SMF may use the following parameters.

The SMF may export, for the PDU session, SMF exported CN-assisted RAN information. For example, in the PDU session establishment process or the PDU session modification process, the SMF provides the SMF exported CN-assisted RAN information to the AMF.

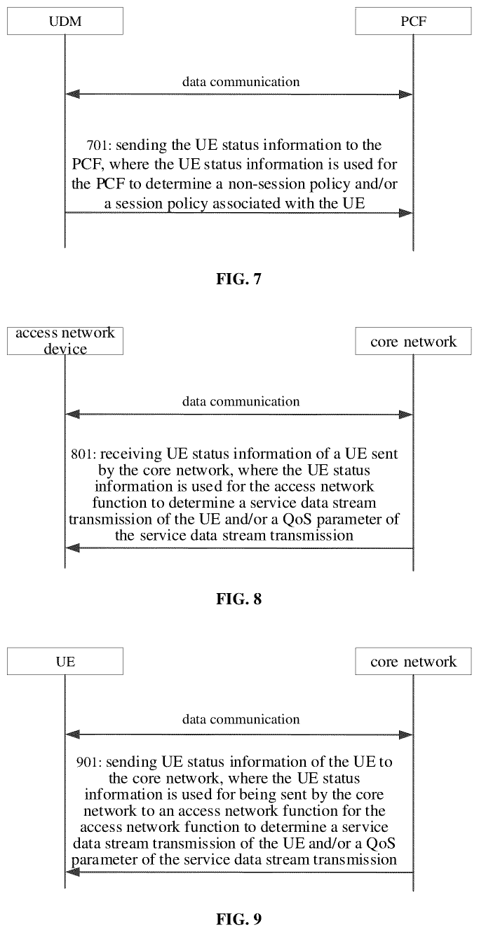

As shown in FIG. 7, the embodiments of the present disclosure provide an information transmission method, performed by a UDM, including step 701.

At step 701, the UE status information is sent to the PCF, where the UE status information is used for the PCF to determine a non-session policy and/or a session policy associated with the UE.

Step 701 may be implemented individually or in combination with step 501 and/or step 601.

If the SMF determines, during the PDU session establishment process, that the PDU session uses the dynamic PCC, the SMF performs PCF selection. Based on the contracting and the application information provided by the AF, the PCF may generate/activate a rule for the corresponding service data stream, e.g., an XR type service rule/multimodal service rule, or generate/activate a data stream PCC rule that enhances the support of the data service (e.g., the XR type service and multimodal service session). (For example, associating the XRM service data stream, matching the XRM service and multimodal service QoS, including the GFBR, PDB, MDBV matching of the XRM and multimodal service data stream, etc.)

The UDM may send the UE status information to the PCF. The condition for the UDM to send the UE status information to the PCF may include, but is not limited to, at least one of the following: the PCF subscribing the UE status change event and the reporting condition being satisfied, or the contracted information or local policy triggering the reporting of the UE status information. According to the subscription and reporting requirement, the UE status information notify reporting is performed.

The PCF formulated policy and charging control policy include two categories: session related policies and non-session related policies. In some embodiments, the non-session related policies include a UE policy provided to the UE, an access and mobility management policy and an SMF selection policy provided to the AMF. The session related policies are mainly provided to the SMF, including a charging policy, a gating and QoS control policy, a usage monitoring policy, an application detection policy, and a session related network capability exposure policy, etc.

The PCF may determine, based on the UE status information as received, the non-session UE policy and/or session policy of the UE. The PCF may set, for different UE statuses, different non-session policies and/or session policies of the UE. The PCF issues the updated non-session policy and/or session policy to the AF and the UE.

For example, when the battery power of the UE is low, or the temperature of the UE is high, the non-session policy and/or session policy may be adjusted to reduce the transmission bandwidth, etc., enabling the energy consumption of the data service to be reduced, thereby increasing the power supply duration of the battery, and reducing the temperature of the UE.

As another example, when the UE is powered by the mains power supply, and the temperature of the UE is low, the non-session policy and/or session policy may be adjusted to increase the transmission bandwidth, and reduce the transmission latency, etc., thereby improving the user experience.

In this way, the PCF sets, based on the UE status information, the non-session policy and/or the session policy of the UE to balance the UE status such as energy consumption of the UE, and the transmission performance of the UE.

As shown in FIG. 8, the embodiments of the present disclosure provide an information transmission method, performed by an access network function, including step 801.

At step 801, UE status information of a UE sent by a core network is received, where the UE status information is used for the access network function to determine a service data stream transmission of the UE and/or a QoS parameter of the service data stream transmission.

The UE status information may be used for indicating a status of the UE. The status of the UE may include, but is not limited to, at least one of the following: a load state of the UE, a battery state of the UE, a temperature state of the UE, a power consumption state of the UE, etc.

The UE status information may be used for determining, by the access network function, the service data stream transmission and/or the QoS parameter of the service data stream transmission. Here, the access network function may be implemented by an access network device such as a base station.

In an embodiment, determining the service data stream transmission by the access network function includes: determining, by the access network function, whether the service data stream transmission is to be performed.

There may be one or more service data streams. The access network function may determine one or more service data streams for transmission.

Here, the QoS parameter includes, but is not limited to, at least one of the following: (1) a QoS class identifier (QCI), an allocation and retention priority (ARP), a guaranteed bit rate (GBR), a maximum bit rate (MBR), an aggregated maximum bit rate (AMBR). Here, the QoS may be specific to the service data stream.

Here, different QoS parameters may be set for different statuses of the UE. For example, different QoS parameters may be set for different battery power levels of the UE. For example, a QoS parameter with low energy consumption may be configured for a power level with a low battery power of the UE.

In an embodiment, the service data stream transmission and/or the QoS parameter of the service data stream transmission may have an impact on the status of the UE.

In an embodiment, the UE status information is at least used for indicating at least one of the following:
a battery power of the UE;
a battery usage duration of the UE;
a power supply mode of the UE;
a temperature status of the UE.

The battery power of the UE may be indicated by a battery power level. For example, from 0% to 100%, the battery power may be divided into a plurality of battery power levels, with different battery power levels indicating different battery power ranges.

The battery usage duration of the UE may include at least one of the following: a usage duration of the remaining battery power, a duration during which the battery has been used, etc.

The power supply mode of the UE may include at least one of the following: a battery powered mode, an external powered mode (e.g., powered by the mains power supply), a hybrid powered mode (powered by the battery combined with the mains power supply, etc.).

The temperature status of the UE may include temperatures of one or more of different temperature measurement points of the UE. For example, the temperature status of the UE may include at least one of the following: a temperature status of the processor of the UE, a temperature status of the battery of the UE.

In an embodiment, the temperature status of the UE is indicated by using a battery temperature level. For example, the temperature status of the UE may be indicated by using three temperature levels, i.e., a high temperature level, a medium temperature level and a low temperature level.

In an embodiment, the service data stream of the UE includes at least one of the following:
an XR service data stream of the UE;
a multimodal data service data stream of the UE.

The XR type service data stream generally has characteristics of high bandwidth, low latency and high reliability requirements, thus leading to outstanding energy consumption of the UE. Here, the service has a strong correlation with the status of the UE as indicated by the UE status information.

The multimodal data service data stream is used for transmitting data in different modalities, and therefore also has the characteristics of high bandwidth, low latency and high reliability requirements, thus leading to outstanding energy consumption of the UE. Here, the service has a strong correlation with the status of the UE as indicated by the UE status information.

For example, the XR type service data stream consumes a significant amount of battery power, and increases the temperature of the UE, and the like.

Here, the access network function, etc., may determine, based on the UE status information, the service data stream that is allowed and/or disallowed to be transmitted, and the QoS parameter of the transmitted service data stream.

In an embodiment, the access network function may determine the service data stream transmission that satisfies the status of the UE indicated by the UE status information, and/or the QoS parameter of the service data stream transmission.

For example, when the battery power of the UE is low, or the temperature of the UE is high, the service data stream transmission may be reduced, enabling the energy consumption of the service data stream transmission to be reduced, thereby increasing the power supply duration of the battery, and reducing the temperature of the UE.

When the battery power of the UE is low, or the temperature of the UE is high, the QoS parameter may be adjusted to reduce the transmission bandwidth, etc., enabling the energy consumption of the service data stream transmission to be reduced, thereby increasing the power supply duration of the battery, and reducing the temperature of the UE.

As another example, when the UE is powered by the mains power supply, and the temperature of the UE is low, the QoS parameter may be adjusted to increase the transmission bandwidth, and reduce the transmission latency, etc., thereby improving the user experience.

Here, the UE status information may be sent by a core network element SMF to the access network function. The UE status information is not sent from the UE directly to the access network function. This can reduce the impact on the air interface data transmission due to the UE sending the UE status information directly to the access network function, and improves compatibility.

In an embodiment, receiving the UE status information of the UE sent by the core network includes:
receiving the UE status information from an SMF of the core network.

The SMF may send the UE status information to the AMF through N2 SM information, and the UE status information is forwarded by the AMF to the access network function for the access network function to perform QoS mapping and transmission of uplink or downlink data streams to better match the XR type service or multimodal service traffic characteristic and energy consumption management.

In an embodiment, the UE status information is sent by the UE to the core network through an NAS message.

The UE may determine its own UE status and send it to the core network through the UE status information. The UE status information may be carried in the NAS message to be sent to the core network, e.g., to the AMF, SMF, PCF, and/or UMD. Then, the UE status information is sent to the access network function by the core network element such as the SMF.

In this way, the UE status information of the UE is sent to the access network function by the SMF, and the access network function determines, based on the UE status information, the service data stream transmission of the UE and/or the QoS parameter of the service data stream transmission. On the one hand, the UE status such as energy consumption of the UE, and the transmission performance of the service data stream such as the XR media service is balanced. On the other hand, sending the UE status information to the access network function through the SMF can reduce the impact on the air interface data transmission due to the UE sending the UE status information directly to the access network function, and improves compatibility.

In an embodiment, the UE status information is sent to the SMF by a UDM; and/or
the UE status information is sent to the SMF by a PCF; and/or
the UE status information is sent to the SMF by the UE.

In an embodiment, the UE status information may be sent by the UE to the SMF. For example, the UE status information may be carried in the NAS to be sent to the SMF.

In an embodiment, the UE status information may be sent by the UE to the core network element in advance, and stored in the UDM.

In an embodiment, the UE status information may be sent by the UE to the core network element in advance, and stored in the PCF.

The SMF may obtain, through subscribing, etc., the UE status information from the UDM and/or PCF. The SMF may also obtain the UE status information from the UDM through retrieving at the UDM, etc.

In an embodiment, the PCF may send, based on subscription information of the SMF, etc., the UE status information to the SMF.

In an embodiment, the SMF retrieves the UE status information in the PCF.

In an embodiment, the UE status information sent by the UDM is sent by the UE to an AF, and sent to the UDM by the AF via an NEF.

In an embodiment, the UE status information may be sent by an application of the UE to the AF of the core network, and sent by the AF to the NEF, and then stored by the NEF in the UDM.

In an embodiment, the UE status information may be associated with a validity duration. The validity duration may be stored in the UDM/UDR and the NF. The UDM may provide the UE status information to the core network element (e.g., the AMF and/or the SMF) within the validity duration. At the expiration of the validity period, each node automatically deletes the UE status information. The UDM may delete the UE status information without an explicit signaling.

In an embodiment, the UDM may pre-authorize the AF and/or the NEF to transmit the UE status information. For example, the UDM may pre-authorize the AF and/or the NEF to transmit a communication signaling carrying the UE status information.

In an embodiment, what the NEF sends to the UDM may be separate UE status information. The UDM may store the separate UE status information.

In an embodiment, what the NEF sends to the UDM may be the expected UE behaviour parameter, and the UE status information may be part of the expected UE behaviour parameter. The UDM may store the expected UE behaviour parameter, where the expected UE behaviour parameter may include the UE status information.

The UE status information stored by the UDM may be identified by using identification information of the UE. Here, the identification information of the UE includes, but is not limited to, a SUPI.

In an embodiment, the expected UE behaviour parameter characterizes the expected behaviour of a UE or a group of UEs. A set of these UE behaviour parameters may be provided through the NEF for storage as part of the UE data.

In an embodiment, the SMF retrieves from the UDM the expected UE behaviour parameter associated with the SMF for a particular PDU session.

The details of the expected UE behaviour parameter may be as shown in Table 1. The UE status information in the expected UE behaviour parameter may include at least one of the following: a power supply mode, a UE temperature, an overheating status, a battery power of the UE, a battery indication.

Upon receiving the UE status information, the UDM may store the UE status information as differently categorized UE status information for reading by different network elements. For example, the UDM may store the UE status information as UE status information for reading by the AMF, and UE status information for reading by the SMF. The UE status information may be stored in information associated with the AMF, and/or the UE status information may be stored in information associated with the SMF.

In an embodiment, the UE status information for reading by the AMF is specific to the UE, and the UE status information for reading by the SMF may be specific to the PDU session of the UE.

The UE status information stored for the AMF may be used for the access network function to determine a transmission parameter of a predetermined data service of the UE.

The UE status information stored for the SMF may be used for the access network function to determine a transmission parameter of a predetermined data service in a particular PDU session of the UE, such as a PDU session corresponding to a PDU session establishment request.

In an embodiment, the UE status information from the UDM is subscribed by the SMF to the UDM.

The SMF may pre-subscribe the UE status information (including: the expected UE behaviour parameter containing the UE status information), and the UDM, upon receiving the UE status information, may notify, through a notification message (e.g., Nudm_SDM_Notification), the subscriber (AMF, SMF, etc.) of the UE status information of the update to the UE status information. The UE status information may be carried in the notification message. The AMF and/or SMF, etc. may obtain the UE status information.

In an embodiment, the UE status information may be identified by using the identification information of the UE.

In an embodiment, the UE status information may be identified by using the DNN/S-NSSAI for association with the PDU session.

For example, the UE status information is carried in the expected UE behaviour parameter. The UDM performs the Nudm_SDM_Notification (the SUPI or internal group identifier, the expected UE behaviour parameter set associated with the SMF, the DNN/S-NSSAI, the suggested number of downlinked data packet, etc.) service operation.

The SMF stores the expected UE behaviour parameter (including the UE status information) as received, and associates, based on the DNN and S-NSSAI included in the message from the UDM, the expected UE behaviour parameter with the PDU session.

The SMF identifies if there are overlapped parameter sets in the expected UE behaviour, and merges the parameter sets if necessary. The SMF may use the following parameters.

The SMF may export, for the PDU session, SMF exported CN-assisted RAN information. For example, in the PDU session establishment process or the PDU session modification process, the SMF provides the SMF exported CN-assisted RAN information to the AMF.

In an embodiment, the UE status information sent by the PCF may be sent by the UE to the AF, and sent to the PCF by the AF or sent to the PCF by the AF via the NEF.

In an embodiment, the UE status information may be sent by the application of the UE to the AF of the core network, and sent by the AF to the PCF. Here, the AF may be a trusted AF.

In an embodiment, the UE status information may be sent by the application of the UE to the AF of the core network, and sent by the AF to the NEF, and then stored by the NEF in the PCF.

In an embodiment, the UE status information is subscribed by the PCF to the NEF.

In an embodiment, the PCF may send, based on subscription information of the SMF, etc., the UE status information to the SMF.

In an embodiment, the PCF may authorize the AF to send the UE status information to the PCF via the NEF.

In an embodiment, the UE status information sent by the UE is sent to the SMF by an AMF, upon receiving a PDU session establishment request carrying the UE status information, through carrying the UE status information in an SM context establishment request.

The UE may send the UE status information to the SMF during the PDU session establishment process after the UE completes registration.

The UE may carry the UE status information in the PDU session establishment request. The AMF may send the SM context establishment request to the SMF after receiving the PDU session establishment request.

In an embodiment, the UE status information may be carried in an N1 SM container of the PDU session establishment request. In response to the PDU session establishment request carrying the UE status information, the AMF may send the UE status information to the SMF.

The AMF obtains the UE status information by reading the N1 SM container.

In an embodiment, the AMF may store the UE status information in the context of the UE.

The AMF may send, by carrying the UE status information in the SM context establishment request, the UE status information to the SMF.

In an embodiment, the UE status information may be carried in the N1 SM container of the SM context establishment request. The SMF obtains the UE status information by reading the N1 SM container.

During the PDU session establishment process, the AMF, upon receiving the PDU session establishment request, may select the SMF used for the PDU session, and sends the SM context establishment request to the selected SMF. The AMF may carry the UE status information in the SM context establishment request.

In an embodiment, the UE status information is carried in at least one of the following:
a PCO in the PDU session establishment request;
UE session management core network capability information in the PDU session establishment request.

If the UE sends the UE status information to the AMF through the PDU session establishment request, the UE status information may be carried in the PCO and/or the UE 5G SM core network capability information in the PDU session establishment request.

In an embodiment, the UE status information may be carried in the PCO and/or the UE 5G SM core network capability information of the N1 SM container in the SM context establishment request.

In an embodiment, receiving the UE status information from the SMF of the core network includes:
receiving, from an AMF, an N2 message and/or an NGAP signaling carrying the UE status information, where the UE status information is sent to the AMF by the SMF through carrying the UE status information in an N2 session message.

The SMF may send the UE status information to the AMF through N2 SM information, and the UE status information is forwarded by the AMF to the access network function for the access network function to perform QoS mapping and transmission of uplink or downlink data streams to better match the XR type service or multimodal service traffic characteristic and energy consumption management. The AMF may send the UE status information to the access network function in the N2 message. The AMF may also send the UE status information to the access network function by using the NGAP signaling.

In an embodiment, the UE status information is further used for the PCF of the core network to determine a non-session policy and/or a session policy associated with the UE.

If the SMF determines, during the PDU session establishment process, that the PDU session uses the dynamic PCC, the SMF performs PCF selection. Based on the contracting and the application information provided by the AF, the PCF may generate/activate a rule for the corresponding service data stream, e.g., an XR type service rule/multimodal service rule, or generate/activate a data stream PCC rule that enhances the support of the data service (e.g., the XR type service and multimodal service session). (For example, associating the XRM service data stream, matching the XRM service and multimodal service QoS, including the GFBR, PDB, MDBV matching of the XRM and multimodal service data stream, etc.)

The SMF reports the UE status information to the PCF. The reporting condition of the SMF may include, but is not limited to, at least one of the following: the PCF subscribing the UE status change event and the reporting condition being satisfied, or the contracted information or local policy triggering the reporting of the UE status information. According to the subscription and reporting requirement, the UE status information notify reporting is performed.

The PCF formulated policy and charging control policy include two categories: session related policies and non-session related policies. In some embodiments, the non-session related policies include a UE policy provided to the UE, an access and mobility management policy and an SMF selection policy provided to the AMF. The session related policies are mainly provided to the SMF, including a charging policy, a gating and QoS control policy, a usage monitoring policy, an application detection policy, and a session related network capability exposure policy, etc.

The PCF may determine, based on the UE status information as received, the non-session UE policy and/or session policy of the UE. The PCF may set, for different UE statuses, different non-session policies and/or session policies of the UE. The PCF issues the updated non-session policy and/or session policy to the AF and the UE.

For example, when the battery power of the UE is low, or the temperature of the UE is high, the non-session policy and/or session policy may be adjusted to reduce the transmission bandwidth, etc., enabling the energy consumption of the data service to be reduced, thereby increasing the power supply duration of the battery, and reducing the temperature of the UE.

As another example, when the UE is powered by the mains power supply, and the temperature of the UE is low, the non-session policy and/or session policy may be adjusted to increase the transmission bandwidth, and reduce the transmission latency, etc., thereby improving the user experience.

In this way, the PCF sets, based on the UE status information, the non-session policy and/or the session policy of the UE to balance the UE status such as energy consumption of the UE, and the transmission performance of the UE.

As shown in FIG. 9, the embodiments of the present disclosure provide an information transmission method, performed by a UE, including step 901.

At step 901, UE status information of a UE is sent to a core network, where the UE status information is used for being sent by the core network to an access network function for the access network function to determine a service data stream transmission of the UE and/or a QoS parameter of the service data stream transmission.

The UE status information may be used for indicating a status of the UE. The status of the UE may include, but is not limited to, at least one of the following: a load state of the UE, a battery state of the UE, a temperature state of the UE, a power consumption state of the UE, etc.

The UE status information may be used for determining, by the access network function, the service data stream transmission and/or the QoS parameter of the service data stream transmission. Here, the access network function may be implemented by an access network device such as a base station.

In an embodiment, determining the service data stream transmission by the access network function includes: determining, by the access network function, whether the service data stream transmission is to be performed.

There may be one or more service data streams. The access network function may determine one or more service data streams for transmission.

Here, the QoS parameter includes, but is not limited to, at least one of the following: (1) a QoS class identifier (QCI), an allocation and retention priority (ARP), a guaranteed bit rate (GBR), a maximum bit rate (MBR), an aggregated maximum bit rate (AMBR). Here, the QoS may be specific to the service data stream.

Here, different QoS parameters may be set for different statuses of the UE. For example, different QoS parameters may be set for different battery power levels of the UE. For example, a QoS parameter with low energy consumption may be configured for a power level with a low battery power of the UE.

In an embodiment, the service data stream transmission and/or the QoS parameter of the service data stream transmission may have an impact on the status of the UE.

In an embodiment, the UE status information is at least used for indicating at least one of the following:
a battery power of the UE;
a battery usage duration of the UE;
a power supply mode of the UE;
a temperature status of the UE.

The battery power of the UE may be indicated by a battery power level. For example, from 0% to 100%, the battery power may be divided into a plurality of battery power levels, with different battery power levels indicating different battery power ranges.

The battery usage duration of the UE may include at least one of the following: a usage duration of the remaining battery power, a duration during which the battery has been used, etc.

The power supply mode of the UE may include at least one of the following: a battery powered mode, an external powered mode (e.g., powered by the mains power supply), a hybrid powered mode (powered by the battery combined with the mains power supply, etc.).

The temperature status of the UE may include temperatures of one or more of different temperature measurement points of the UE. For example, the temperature status of the UE may include at least one of the following: a temperature status of the processor of the UE, a temperature status of the battery of the UE.

In an embodiment, the temperature status of the UE is indicated by using a battery temperature level. For example, the temperature status of the UE may be indicated by using three temperature levels, i.e., a high temperature level, a medium temperature level and a low temperature level.

In an embodiment, the service data stream of the UE includes at least one of the following:
an XR service data stream of the UE;
a multimodal data service data stream of the UE.

The XR type service data stream generally has characteristics of high bandwidth, low latency and high reliability requirements, thus leading to outstanding energy consumption of the UE. Here, the service has a strong correlation with the status of the UE as indicated by the UE status information.

The multimodal data service data stream is used for transmitting data in different modalities, and therefore also has the characteristics of high bandwidth, low latency and high reliability requirements, thus leading to outstanding energy consumption of the UE. Here, the service has a strong correlation with the status of the UE as indicated by the UE status information.

For example, the XR type service data stream consumes a significant amount of battery power, and increases the temperature of the UE, and the like.

Here, the access network function, etc., may determine, based on the UE status information, the service data stream that is allowed and/or disallowed to be transmitted, and the QoS parameter of the transmitted service data stream.

In an embodiment, the access network function may determine the service data stream transmission that satisfies the status of the UE indicated by the UE status information, and/or the QoS parameter of the service data stream transmission.

For example, when the battery power of the UE is low, or the temperature of the UE is high, the service data stream transmission may be reduced, enabling the energy consumption of the service data stream transmission to be reduced, thereby increasing the power supply duration of the battery, and reducing the temperature of the UE.

When the battery power of the UE is low, or the temperature of the UE is high, the QoS parameter may be adjusted to reduce the transmission bandwidth, etc., enabling the energy consumption of the service data stream transmission to be reduced, thereby increasing the power supply duration of the battery, and reducing the temperature of the UE.

As another example, when the UE is powered by the mains power supply, and the temperature of the UE is low, the QoS parameter may be adjusted to increase the transmission bandwidth, and reduce the transmission latency, etc., thereby improving the user experience.

Here, the UE status information may be sent by a core network element SMF to the access network function. The UE status information is not sent from the UE directly to the access network function. This can reduce the impact on the air interface data transmission due to the UE sending the UE status information directly to the access network function, and improves compatibility.

In an embodiment, the UE status information is used for being sent by an SMF of the core network to the access network function.

In an embodiment, the UE status information is sent by the UE to the core network through an NAS message.

The UE may determine its own UE status and send it to the core network through the UE status information. The UE status information may be carried in the NAS message to be sent to the core network, e.g., to the AMF, SMF, PCF, and/or UMD. Then, the UE status information is sent to the access network function by the core network element such as the SMF.

In this way, the UE status information of the UE is sent to the access network function by the SMF, and the access network function determines, based on the UE status information, the service data stream transmission of the UE and/or the QoS parameter of the service data stream transmission. On the one hand, the UE status such as energy consumption of the UE, and the transmission performance of the service data stream such as the XR media service is balanced. On the other hand, sending the UE status information to the access network function through the SMF can reduce the impact on the air interface data transmission due to the UE sending the UE status information directly to the access network function, and improves compatibility.

In an embodiment, sending the UE status information of the UE to the core network includes at least one of the following:
sending the UE status information to an SMF of the core network;
sending the UE status information to a UDM of the core network;
sending the UE status information to a PCF of the core network.

In an embodiment, the UE status information may be sent by the UE to the SMF. For example, the UE status information may be carried in the NAS to be sent to the SMF.

In an embodiment, the UE status information may be sent by the UE to the core network element in advance, and stored in the UDM.

In an embodiment, the UE status information may be sent by the UE to the core network element in advance, and stored in the PCF.

The SMF may obtain, through subscribing, etc., the UE status information from the UDM and/or PCF. The SMF may also obtain the UE status information from the UDM through retrieving at the UDM, etc.

In an embodiment, the PCF may send, based on subscription information of the SMF, etc., the UE status information to the SMF.

In an embodiment, the SMF retrieves the UE status information in the PCF.

In an embodiment, sending the UE status information to the SMF of the core network includes:
sending a PDU session establishment request carrying the UE status information to an AMF, where the UE status information is sent to the SMF by the AMF through carrying the UE status information in an SM context establishment request.

The UE may send the UE status information to the SMF during the PDU session establishment process after the UE completes registration.

The UE may carry the UE status information in the PDU session establishment request. The AMF may send the SM context establishment request to the SMF after receiving the PDU session establishment request.

In an embodiment, the UE status information may be carried in an N1 SM container of the PDU session establishment request. In response to the PDU session establishment request carrying the UE status information, the AMF may send the UE status information to the SMF.

The AMF obtains the UE status information by reading the N1 SM container.

In an embodiment, the AMF may store the UE status information in the context of the UE.

The AMF may send, by carrying the UE status information in the SM context establishment request, the UE status information to the SMF.

In an embodiment, the UE status information may be carried in the N1 SM container of the SM context establishment request. The SMF obtains the UE status information by reading the N1 SM container.

During the PDU session establishment process, the AMF, upon receiving the PDU session establishment request, may select the SMF used for the PDU session, and sends the SM context establishment request to the selected SMF. The AMF may carry the UE status information in the SM context establishment request.

In an embodiment, the UE status information is carried in at least one of the following:
a PCO in the PDU session establishment request;
UE session management core network capability information in the PDU session establishment request.

If the UE sends the UE status information to the AMF through the PDU session establishment request, the UE status information may be carried in the PCO and/or the UE 5G SM core network capability information in the PDU session establishment request.

In an embodiment, the UE status information may be carried in the PCO and/or the UE 5G SM core network capability information of the N1 SM container in the SM context establishment request.

In an embodiment, sending the UE status information to the UDM of the core network includes:
sending the UE status information to an AF, where the UE status information is sent to the UDM by the AF via an NEF.

In an embodiment, the UE status information may be sent by an application of the UE to the AF of the core network, and sent by the AF to the NEF, and then stored by the NEF in the UDM.

In an embodiment, the UE status information may be associated with a validity duration. The validity duration may be stored in the UDM/UDR and the NF. The UDM may provide the UE status information to the core network element (e.g., the AMF and/or the SMF) within the validity duration. At the expiration of the validity period, each node automatically deletes the UE status information. The UDM may delete the UE status information without an explicit signaling.

In an embodiment, the UDM may pre-authorize the AF and/or the NEF to transmit the UE status information. For example, the UDM may pre-authorize the AF and/or the NEF to transmit a communication signaling carrying the UE status information.

In an embodiment, what the NEF sends to the UDM may be separate UE status information. The UDM may store the separate UE status information.

In an embodiment, what the NEF sends to the UDM may be the expected UE behaviour parameter, and the UE status information may be part of the expected UE behaviour parameter. The UDM may store the expected UE behaviour parameter, where the expected UE behaviour parameter may include the UE status information.

The UE status information stored by the UDM may be identified by using identification information of the UE. Here, the identification information of the UE includes, but is not limited to, a SUPI.

In an embodiment, the expected UE behaviour parameter characterizes the expected behaviour of a UE or a group of UEs. A set of these UE behaviour parameters may be provided through the NEF for storage as part of the UE data.

In an embodiment, the SMF retrieves from the UDM the expected UE behaviour parameter associated with the SMF for a particular PDU session.

The details of the expected UE behaviour parameter may be as shown in Table 1. The UE status information in the expected UE behaviour parameter may include at least one of the following: a power supply mode, a UE temperature, an overheating status, a battery power of the UE, a battery indication.

Upon receiving the UE status information, the UDM may store the UE status information as differently categorized UE status information for reading by different network elements. For example, the UDM may store the UE status information as UE status information for reading by the AMF, and UE status information for reading by the SMF. The UE status information may be stored in information associated with the AMF, and/or the UE status information may be stored in information associated with the SMF.

In an embodiment, the UE status information for reading by the AMF is specific to the UE, and the UE status information for reading by the SMF may be specific to the PDU session of the UE.

The UE status information stored for the AMF may be used for the access network function to determine a transmission parameter of a predetermined data service of the UE.

The UE status information stored for the SMF may be used for the access network function to determine a transmission parameter of a predetermined data service in a particular PDU session of the UE, such as a PDU session corresponding to a PDU session establishment request.

In an embodiment, the UE status information from the UDM is subscribed by the SMF to the UDM.

The SMF may pre-subscribe the UE status information (including: the expected UE behaviour parameter containing the UE status information), and the UDM, upon receiving the UE status information, may notify, through a notification message (e.g., Nudm_SDM_Notification), the subscriber (AMF, SMF, etc.) of the UE status information of the update to the UE status information. The UE status information may be carried in the notification message. The AMF and/or SMF, etc. may obtain the UE status information.

In an embodiment, the UE status information may be identified by using the identification information of the UE.

In an embodiment, the UE status information may be identified by using the DNN/S-NSSAI for association with the PDU session.

For example, the UE status information is carried in the expected UE behaviour parameter. The UDM performs the Nudm_SDM_Notification (the SUPI or internal group identifier, the expected UE behaviour parameter set associated with the SMF, the DNN/S-NSSAI, the suggested number of downlinked data packet, etc.) service operation.

The SMF stores the expected UE behaviour parameter (including the UE status information) as received, and associates, based on the DNN and S-NSSAI included in the message from the UDM, the expected UE behaviour parameter with the PDU session.

The SMF identifies if there are overlapped parameter sets in the expected UE behaviour, and merges the parameter sets if necessary. The SMF may use the following parameters.

The SMF may export, for the PDU session, SMF exported CN-assisted RAN information. For example, in the PDU session establishment process or the PDU session modification process, the SMF provides the SMF exported CN-assisted RAN information to the AMF.

In an embodiment, sending the UE status information to the PCF of the core network includes:
sending the UE status information to an AF, where the UE status information is sent by the AF to the PCF, or is sent by the AF to the PCF via an NEF.

In an embodiment, the UE status information may be sent by the application of the UE to the AF of the core network, and sent by the AF to the PCF. Here, the AF may be a trusted AF.

In an embodiment, the UE status information may be sent by the application of the UE to the AF of the core network, and sent by the AF to the NEF, and then stored by the NEF in the PCF.

In an embodiment, the UE status information is subscribed by the PCF to the NEF.

In an embodiment, the PCF may send, based on subscription information of the SMF, etc., the UE status information to the SMF.

In an embodiment, the PCF may authorize the AF to send the UE status information to the PCF via the NEF.

In an embodiment, the UE status information is used for being sent to the access network function by an SMF of the core network.

The SMF may send the UE status information to the AMF through N2 SM information, and the UE status information is forwarded by the AMF to the access network function for the access network function to perform QoS mapping and transmission of uplink or downlink data streams to better match the XR type service or multimodal service traffic characteristic and energy consumption management.

In an embodiment, the UE status information is further used for a PCF of the core network to determine a non-session policy and/or a session policy associated with the UE.

If the SMF determines, during the PDU session establishment process, that the PDU session uses the dynamic PCC, the SMF performs PCF selection. Based on the contracting and the application information provided by the AF, the PCF may generate/activate a rule for the corresponding service data stream, e.g., an XR type service rule/multimodal service rule, or generate/activate a data stream PCC rule that enhances the support of the data service (e.g., the XR type service and multimodal service session). (For example, associating the XRM service data stream, matching the XRM service and multimodal service QoS, including the GFBR, PDB, MDBV matching of the XRM and multimodal service data stream, etc.)

The SMF reports the UE status information to the PCF. The reporting condition of the SMF may include, but is not limited to, at least one of the following: the PCF subscribing the UE status change event and the reporting condition being satisfied, or the contracted information or local policy triggering the reporting of the UE status information. According to the subscription and reporting requirement, the UE status information notify reporting is performed.

The PCF formulated policy and charging control policy include two categories: session related policies and non-session related policies. In some embodiments, the non-session related policies include a UE policy provided to the UE, an access and mobility management policy and an SMF selection policy provided to the AMF. The session related policies are mainly provided to the SMF, including a charging policy, a gating and QoS control policy, a usage monitoring policy, an application detection policy, and a session related network capability exposure policy, etc.

The PCF may determine, based on the UE status information as received, the non-session UE policy and/or session policy of the UE. The PCF may set, for different UE statuses, different non-session policies and/or session policies of the UE. The PCF issues the updated non-session policy and/or session policy to the AF and the UE.

For example, when the battery power of the UE is low, or the temperature of the UE is high, the non-session policy and/or session policy may be adjusted to reduce the transmission bandwidth, etc., enabling the energy consumption of the data service to be reduced, thereby increasing the power supply duration of the battery, and reducing the temperature of the UE.

As another example, when the UE is powered by the mains power supply, and the temperature of the UE is low, the non-session policy and/or session policy may be adjusted to increase the transmission bandwidth, and reduce the transmission latency, etc., thereby improving the user experience.

In this way, the PCF sets, based on the UE status information, the non-session policy and/or the session policy of the UE to balance the UE status such as energy consumption of the UE, and the transmission performance of the UE.

To further explain any embodiments of the present disclosure, several specific embodiments are provided below.

Here, the SMF may send the UE status information to the access network function for the access network function to determine the QoS of the XR service and/or media service data stream, thereby better matching the XR media service traffic characteristic and energy consumption management, including supporting the consideration of the balance of throughput of the device battery duration, latency, reliability, and other factors, ensuring service requirements and user experience.

The obtaining of the UE status information by the SMF may be divided into two ways. One is obtaining from the UE in the following PDU session establishment process, including the PCO (Example I), and the UE 5G SM core network capability (Example III). The other is that the AF sends the UE status information to the network via the NEF (Example II).

### Example I

In the PDU session establishment process, the SMF sends the UE status information to the RAN through the N2 SM information carrying UE status information, and the UE status information carried in the N2 SM information is sent by the AMF to the access network function.

During the PDU session establishment process, the UE sends the UE status information (including: the battery power of the UE, the battery usage duration of the UE, the power supply mode of the UE, the temperature status of the UE) to the network by carrying the UE status information in the PCO. The UE status information may be used for the network to perform the execution and reporting of the corresponding UE status information subscription event, or perform the policy decision and execution of the XR media service data stream or QoS stream (e.g., QoS authorization, generation and update of the PCC rule, etc.).

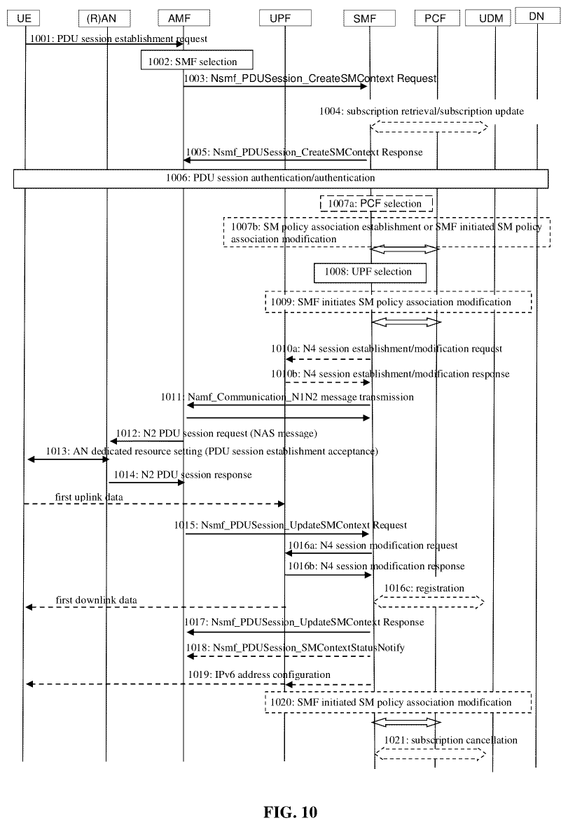

As shown in FIG. 10, during the PDU session establishment process, the specific steps by which the UE sends the UE status information to the SMF by carrying the UE status information in the PCO and the SMF sends the UE status information to the access network function include the following steps.

At step 1001, the UE supports the capability of providing the UE status information to the network side, and the UE may carry the UE status information in the PDU session establishment request message, e.g., in the PCO of the PDU session establishment request message, and the PCO may be carried in the N1 SM container.

At step 1002 and step 1003, the AMF stores the UE status information in the context of the UE. The SMF selects the corresponding SMF and sends the SM context establishment request. The SM context establishment request carries the UE status information carried in the PCO of the N1 SM container in step 1001.

At step 1004, the SMF checks the contracted data and/or event subscription and, in conjunction with the local policy, confirms whether the session can be created, whether to perform the reporting of the subscription event, whether to perform the local policy and QoS authorization (if no PCF is deployed, the SMF performs the static rule activation and QoS authorization), etc.

For example, if the UE status change event is subscribed, the SMF confirms whether the status of the UE is changed or whether the subscription reporting condition is satisfied, and performs the notify reporting according to the subscription and reporting requirement.

For example, the SMF confirms whether the UE status information complies with the user contracting and local policy (e.g., whether the current status of the UE is available for session creation). If the session creation requirement is not satisfied, the session creation for the XRM service/multimodal service may be rejected, or the session creation may be accepted based on the local policy but the XRM service/multimodal service is not supported.

At step 1007, if the PDU session uses the dynamic PCC, the SMF performs PCF selection; otherwise, the SMF performs the local policy. The PDU session request supports the XRM service/multimodal service, and the SMF and the PCF, based on the contracting and the application information provided by the AF, generate/activate the corresponding XRM rule/multimodal data rule, or generate/activate the data stream PCC rule that enhances the support of the XRM and multimodal session (For example, associating the XRM service data stream, matching the XRM service and multimodal service QoS, including the GFBR, PDB, MDBV matching of the XRM and multimodal service data stream, etc.). The SMF reports the UE status information to the PCF. The reporting condition may be that the PCF subscribes the UE status change event and the reporting condition is satisfied, or the contracted information or local policy triggers the reporting of the UE status information. According to the subscription and reporting requirement, the UE status information notify reporting is performed.

At step 1011 and step 1012, the UE status information is sent to the AMF through the N2 SM information, and is forwarded by the AMF to the RAN for the RAN to perform QoS mapping and transmission of uplink or downlink data streams to better match the XR media service traffic characteristic and energy consumption management.

### Example II

The UE status information is sent to the network by the AF via the NEF and stored in the UDM, and obtained by the SMF/AMF through subscription, the specific steps of which are shown in FIG. 11 and include the following steps.

At step 1100, the NF subscribes the UDM notification of the UE and/or UE group data update. (i.e., the NF or AMF subscribes to the UDM for the XRM event information, such as the UE status information).

As step 1101, the AF provides the NEF with the addition or update of one or more parameters through at least one of: the Nnef_ParameterProvision_Create, the Nnef_ParameterProvision_Update. In some embodiments, the parameters include the UE status information. Here, the UE status information is obtained by the AF from the application of the UE.

Here, the GPSI may be used to identify the UE, and the Transaction Reference ID is used to identify the transaction request between the NEF and the AF. For the case of Nnef_ParameterProvision_Create, the NEF assigns the Transaction Reference ID to the Nnef ParameterProvision_Create request.

The NEF determines, by checking the identifier of the requestor (e.g., AF identifier), whether the requestor is allowed to perform the requested service operation.

The payload of the Nnef_ParameterProvision_Update Request may include at least one of the following parameters:
1. the expected UE behaviour parameter, here, the UE status information may be sent to the NEF as the expected UE behaviour parameter;
2. the UE status information, where the UE status information may be sent to the NEF as separate information;
3. the network configuration parameter.

At step 1102, if the AF is authorized by the NEF to provide the parameter (the expected UE behaviour parameter), the NEF requests, through the message such as the Nudm_ParameterProvision_Create request, the Nudm_ParameterProvision_Update request, the creation, update, storage, and/or deletion of the provided parameter as part of the subscription data, and the message includes the provided parameter (the expected UE behaviour parameter) and the NEF reference ID. The NEF stores the UE status information into the UDM.

If the AF is not authorized to provide the parameter, the NEF indicates the reason for the failure in the Nnef_ParameterProvision_Create/Update Response message in step 1102. Step 1107 is not performed in this case.

If the NEF does not receive the DNN and/or S-NSSAI from the AF, and such information is configured in the 5GC as required, the NEF determines the DNN and/or S-NSSAI based on the AF identifier.

At step 1103, the corresponding subscription information may be read from the UDR through the Nudr_DM_Query to validate the required data update and authorize the change to these parameters for this subscriber or corresponding AF group.

At step 1104, if the UDM authorizes the AF to provide the parameter for the subscriber, the UDM parses the GPSI as a SUPI, and through the Nudr_DM_Create/Update Request message, the UDM requests the creation, update or deletion of the provided parameter that is part of the subscription data. The message above includes the provided parameter.

If a new 5G VN group is created, the UDM shall assign a unique internal group ID to the 5GVN Group, and include the newly assigned internal group ID in the Nudr_DM_Create Request message. If the 5G VN group membership list is changed or the 5G VN group data is changed, the UDM updates, based on the AF/NEF request, the subscription data of the UE and/or UE group.

The UDR stores the provided parameter as part of the subscription data of the UE and/or UE group, and responds with a Nudr_DM_Create/Update Response message.

When the 5G VN group data is updated, the UDR notifies the subscribed PCF by sending the Nudr_DM_Notify.

If the AF is not authorized to provide the parameter, the UDM proceeds to step 1105, indicates the reason for the failure in the Nudm_ParameterProvision_Update Response message, and does not perform step 1107.

The UDM categorizes the received parameter (e.g., the expected UE behaviour parameter including the UE status information) into the AMF related parameter and the SMF related parameter. The UDM may use the AF identifier received from the NEF in step 1102 to associate the received parameter with a specific subscribed DNN and/or S-NSSAI. The UDM stores the SMF related parameter under the corresponding session management subscription data type.

Each parameter or parameter set may be associated with a validity time. The validity time is stored in the UDM/UDR and in each NF, and the parameter is provided to, e.g., the AMF or SMF. At the expiration of the validity period, each node automatically deletes the parameter without an explicit signaling.

At 1105, the UDM responds to the request by using the Nudm_ParameterProvision_Create Response, Nudm_ParameterProvision_Update Response. If the process fails, the reason value is used to indicate the reason.

At 1106, the NEF responds to the request by using the Nnef_ParameterProvision_Create Response, Nnef_ParameterProvision_Update Response. If the process fails, the reason value is used to indicate the reason.

At 1107, the UDM notifies, through the Nudm_SDM_Notification Notify message, the subscribed network function (e.g., AMF, SMF) of the updated subscription data of the UE and/or UE group. (This step is performed only after step 1104 is successful).

a) If the NF is the AMF, the UDM performs the Nudm_SDM_Notification (the SUPI or internal group identifier, the expected UE behaviour parameter associated with the AMF, the subscribed periodic registration timer, the subscribed active time, etc.) service operation. The AMF identifies if there are overlapped parameter sets, and merges the parameter sets in the expected UE behaviour if necessary. The AMF uses the received parameter to export the appropriate UE configuration of the NAS parameter, and exports the core network assisted RAN parameter. The AMF may determine the registration area based on the parameter stationary indicator or the expected UE moving trajectory.

b) If the NF is the SMF, the UDM performs the Nudm_SDM_Notification (the SUPI or internal group identifier, the expected UE behaviour Parameter set associated with the SMF, the DNN/S-NSSAI, the suggested number of downlink packets, etc.) service operation.

The SMF stores the expected UE behaviour parameter (including the UE status information) as received, and associates, based on the DNN and S-NSSAI included in the message from the UDM, the expected UE behaviour parameter with the PDU session.

The SMF identifies if there are overlapped parameter sets in the expected UE behaviour, and merges the parameter sets if necessary. The SMF may use the following parameters:

The SMF may export, for the PDU session, the SMF exported CN-assisted RAN information. For example, in the PDU session establishment process or the PDU session modification process, the SMF provides the SMF exported CN-assisted RAN information to the AMF.

The expected UE behaviour parameter characterizes the expected behaviour of a UE or a group of UEs. A set of these UE behaviour parameters may be provided through the NEF for storage as part of the UE data.

The UE status information is obtained and stored in the UDM. The SMF or AMF subscribes the UE status information by subscribing the UDM event (the UE status information event).

The expected UE behaviour parameter, e.g., UE status information, may be stored in the UDM as the AMF related expected UE behaviour parameter (UE level), and the SMF related expected UE behaviour parameter (PDU level), respectively (i.e., the UE level information is stored as the AMF related expected UE behaviour parameter; and the PDU level information is stored as the SMF related expected UE behaviour parameter).

The AMF retrieves, from the UDM, the AMF related expected UE behaviour parameter that may be related to the PDU sessions and SMS transmission.

The SMF retrieves, from the UDM, the SMF related expected UE behaviour parameter for a specific PDU session.

The details of the expected UE behaviour parameter may be shown in Table 1.

### Example III

The scenarios in which the SMF obtains the UE status information through the UE 5G SM core network capability are as follows.

During the PDU session establishment process, the UE status information, as the UE 5G SM core network capability, is provided to the network; the UE status information may be used for the network to perform the execution and reporting of the corresponding UE status information subscription event, or perform the policy decision and execution of the XRM service data stream or QoS stream (e.g., QoS authorization, generation and update of the PCC rule, etc.).

As shown in FIG. 10, during the PDU session establishment process, the specific steps by which the UE carries the UE status information in the PDU session establishment request message, e.g., the PDU session establishment request message, e.g., sent to the SMF in the 5G SM core network capability, and sent by the SMF to the access network function include the following steps.

At step 1001, the UE sends the NAS message to the AMF to initiate the PDU session establishment process requested by the UE. The N1 SM container carries the session creation request, the request message carries the UE 5G SM core network capability, and the UE 5G SM core network capability includes the UE status information to inform the network of the UE status information.

At step 1002 and step 1003, the AMF stores the UE status information in the context of the UE, selects the corresponding SMF, and sends the SM context establishment request, where the SM context establishment request carries the UE status information carried in the 5G SM core network capability of the N1 SM container in step 1001.

At step 1004, the SMF checks the contracted data and/or event subscription and, in conjunction with the local policy, confirms whether the session can be created, whether to perform the reporting of the subscription event, whether to perform the local policy and QoS authorization (if no PCF is deployed, the SMF performs the static rule activation and QoS authorization), etc.

For example, if the SMF subscribes the UE status change event, the SMF confirms whether the status of the UE is changed or whether the subscription reporting condition is satisfied, and performs the notify reporting according to the subscription and reporting requirement.

For example, the SMF confirms whether the UE status information complies with the user contracting and local policy (e.g., whether the current status of the UE is available for session creation). If the session creation requirement is not satisfied, the session creation for the XRM service/multimodal service may be rejected, or the session creation may be accepted based on the local policy but the XRM service/multimodal service is not supported.

At step 1004, based on the SMF decision, the corresponding message for creating the SM context is returned, or the response message is updated; if the session creation is rejected, the corresponding reason value for the rejection is carried; optionally, if support for the XRM service/multimodal service is rejected, the corresponding reason value indicating that the 5GC does not support the XRM service/multimodal service is carried.

At step 1007, if the PDU session uses the dynamic PCC, the SMF performs PCF selection; otherwise, the SMF performs the local policy. The PDU session request supports the XRM service/multimodal service, and the SMF and the PCF, based on the contracting and the application information provided by the AF, generate/activate the corresponding XRM rule/multimodal data rule, or generate/activate the data stream PCC rule that enhances the support of the XRM and multimodal session (For example, associating the XRM service data stream, matching the XRM service and multimodal service QoS, including the GFBR, PDB, MDBV matching of the XRM and multimodal service data stream, etc.). The SMF reports the UE status information to the PCF. The reporting condition may be that the PCF subscribes the UE status change event and the reporting condition is satisfied, or the contracted information or local policy triggers the reporting of the UE status information. According to the subscription and reporting requirement, the UE status information notify reporting is performed.

At step 1011 and step 1012, the UE status information is sent to the AMF through the N2 SM information, and is forwarded by the AMF to the RAN for the RAN to perform QoS mapping and transmission of uplink or downlink data streams to better match the XR media service traffic characteristic and energy consumption management.

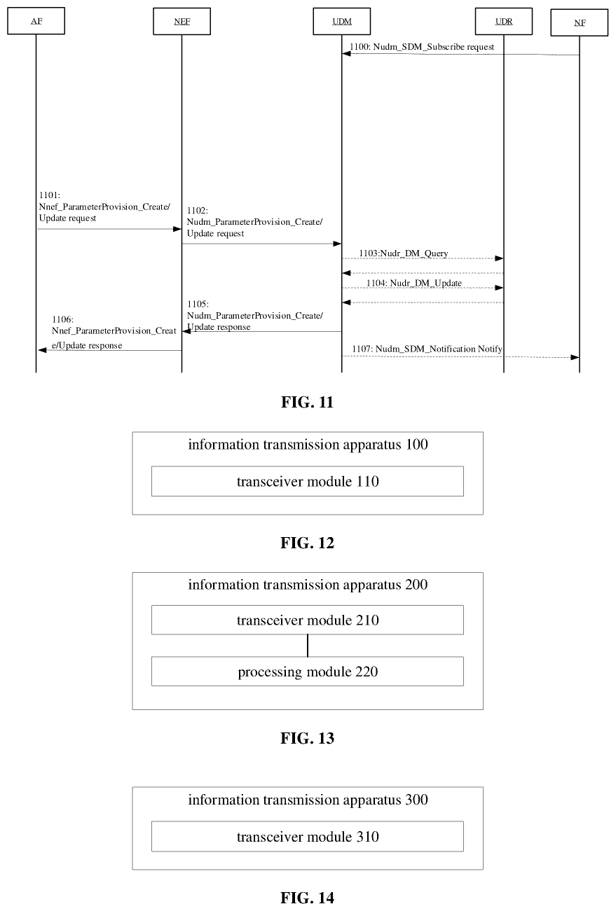

As shown in FIG. 12, the embodiments of the present disclosure provide an information transmission apparatus 100 that is applied in an SMF and includes:
a transceiver module 110, configured to send UE status information of a UE to an access network function, where the UE status information is used for the access network function to determine a service data stream transmission of the UE and/or a QoS parameter of the service data stream transmission.

In an embodiment, the transceiver module 110 is further configured to perform at least one of:
receive the UE status information sent by the UE;
receive the UE status information from a UDM; and
receive the UE status information from a PCF.

In an embodiment, the transceiver module 110 is specifically configured to:
receive an SM context establishment request sent by an AMF to an SMF, where the SM context establishment request carries the UE status information, and the SM context establishment request is sent by the AMF upon receiving a PDU session establishment request carrying the UE status information.

In an embodiment, the UE status information is carried in at least one of:
a PCO in the PDU session establishment request;
UE session management core network capability information in the PDU session establishment request.

In an embodiment, the transceiver module 110 is specifically configured to:
receive, from the UDM, an expected UE behaviour parameter carrying the UE status information.

In an embodiment, the transceiver module 110 is specifically configured to:
receive, from the UDM, the UE status information stored by the UDM for the SMF.

In an embodiment, the UE status information from the UDM is subscribed by the SMF to the UDM.

In an embodiment, the transceiver module 110 is further configured to:
send the UE status information to a PCF, where the UE status information is used for the PCF to determine a non-session policy and/or a session policy associated with the UE.

In an embodiment, sending the UE status information of the UE to the access network function includes:
sending an N2 session message carrying the UE status information to an AMF, where the UE status information is sent to the access network function by the AMF through carrying the UE status information in an N2 message and/or an NGAP signaling.

In an embodiment, the UE status information is at least used for indicating at least one of:
a battery power of the UE;
a battery usage duration of the UE;
a power supply mode of the UE;
a temperature status of the UE.

In an embodiment, the service data stream of the UE includes at least one of:
an XR type service data stream of the UE;
a multimodal data service data stream of the UE.

As shown in FIG. 13, the embodiments of the present disclosure provide an information transmission apparatus 200 that is applied in a UDM and includes:
a transceiver module 210, configured to send UE status information of a UE to an SMF, where the UE status information is used for being sent by the SMF to an access network function for the access network function to determine a service data stream transmission of the UE and/or a QoS parameter of the service data stream transmission.

In an embodiment, the transceiver module 210 is further configured to:
receive the UE status information from an NEF, where the UE status information is received by an AF from the UE and sent by the AF to the NEF.

In an embodiment, the apparatus further includes a processing module 220, configured to:
store the UE status information for the SMF.

In an embodiment, the transceiver module 210 is specifically configured to:
receive, from the NEF, an expected UE behaviour parameter carrying the UE status information.

In an embodiment, the transceiver module 210 is specifically configured to:
send, to the SMF, the expected UE behaviour parameter carrying the UE status information.

In an embodiment, the transceiver module 210 is specifically configured to:
obtain subscription information from a UDR; and
receive, in response to the subscription information indicating permission to store the UE status information, the UE status information from the NEF.

In an embodiment, the UE status information is subscribed by the SMF to the UDM.

In an embodiment, the transceiver module 210 is further configured to:
send the UE status information to a PCF, where the UE status information is used for the PCF to determine a non-session policy and/or a session policy associated with the UE.

In an embodiment, the UE status information is at least used for indicating at least one of:
a battery power of the UE;
a battery usage duration of the UE;
a power supply mode of the UE;
a temperature status of the UE.

In an embodiment, the service data stream of the UE includes at least one of:
an XR type service data stream of the UE;
a multimodal data service data stream of the UE.

As shown in FIG. 14, the embodiments of the present disclosure provide an information transmission apparatus 300 that is applied in an access network function and includes:
a transceiver module 310, configured to receive UE status information of a UE sent by a core network, where the UE status information is used for an access network function to determine a service data stream transmission of the UE and/or a QoS parameter of the service data stream transmission.

In an embodiment, the transceiver module 310 is specifically configured to:
receive the UE status information from an SMF of the core network.

In an embodiment, the UE status information is sent to the SMF by a UDM; and/or
the UE status information is sent to the SMF by a PCF; and/or
the UE status information is sent to the SMF by the UE.

In an embodiment, the UE status information sent by the UDM is sent by the UE to an AF, and sent to the UDM by the AF via an NEF.

In an embodiment, the UE status information sent by the PCF is sent by the UE to an AF, and sent to the PCF by the AF or sent to the PCF by the AF via an NEF.

In an embodiment, the UE status information sent by the UE is sent to the SMF by an AMF, upon receiving a PDU session establishment request carrying the UE status information, through carrying the UE status information in an SM context establishment request.

In an embodiment, the UE status information is carried in at least one of:
a PCO in the PDU session establishment request; and
UE session management core network capability information in the PDU session establishment request.

In an embodiment, the transceiver module 310 is specifically configured to:
receive, from an AMF, an N2 message and/or an NGAP signaling carrying the UE status information, where the UE status information is sent to the AMF by the SMF through carrying the UE status information in an N2 session message.

In an embodiment, the UE status information is further used for a PCF of the core network to determine a non-session policy and/or a session policy associated with the UE.

In an embodiment, the UE status information is at least used for indicating at least one of:
a battery power of the UE;
a battery usage duration of the UE;
a power supply mode of the UE;
a temperature status of the UE.

In an embodiment, the service data stream of the UE includes at least one of:
an XR service data stream of the UE;
a multimodal data service data stream of the UE.

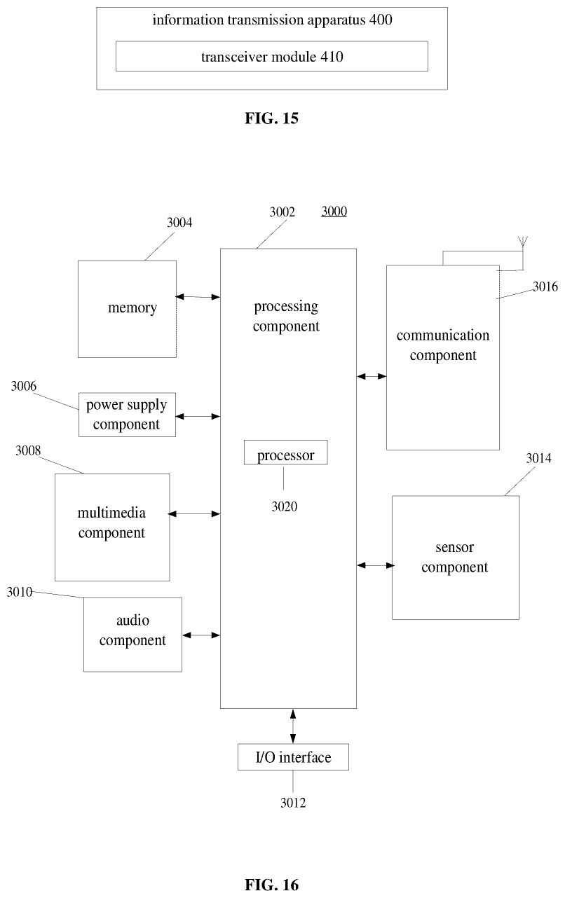

As shown in FIG. 15, the embodiments of the present disclosure provide an information transmission apparatus 400 that is applied in a UE and includes:
a transceiver module 410, configured to send UE status information of the UE to a core network, where the UE status information is used for being sent by the core network to an access network function for the access network function to determine a service data stream transmission of the UE and/or a QoS parameter of the service data stream transmission.

In an embodiment, the transceiver module 410 is specifically configured to perform at least one of:
send the UE status information to an SMF of the core network;
send the UE status information to a UDM of the core network;
send the UE status information to a PCF of the core network.

In an embodiment, the transceiver module 410 is specifically configured to:
send a PDU session establishment request carrying the UE status information to an AMF, where the UE status information is sent to the SMF by the AMF through carrying the UE status information in an SM context establishment request.

In an embodiment, the UE status information is carried in at least one of:
a PCO in the PDU session establishment request;
UE session management core network capability information in the PDU session establishment request.

In an embodiment, the transceiver module 410 is specifically configured to:
send the UE status information to an AF, where the UE status information is sent to the UDM by the AF via an NEF.

In an embodiment, the transceiver module 410 is specifically configured to:
send the UE status information to an AF, where the UE status information is sent by the AF to the PCF, or is sent by the AF to the PCF via an NEF.

In an embodiment, the UE status information is used for being sent to the access network function by an SMF of the core network.

In an embodiment, the UE status information is further used for a PCF of the core network to determine a non-session policy and/or a session policy associated with the UE.

In an embodiment, the UE status information is at least used for indicating at least one of:
a battery power of the UE;
a battery usage duration of the UE;
a power supply mode of the UE;
a temperature status of the UE.

In an embodiment, the service data stream of the UE includes at least one of:
an XR service data stream of the UE;
a multimodal data service data stream of the UE.

It should be noted that those skilled in the art can understand that the apparatuses provided in the embodiments of the present disclosure may be performed individually or in combination with some apparatuses in the embodiments of the present disclosure or some apparatuses in the related art.

With respect to the apparatus in the above embodiments, the specific manner in which each module performs an operation has been described in detail in the embodiments relating to the method, and will not be described in detail here.

The embodiments of the present disclosure provide a communication device, including:
a processor; and
a memory, configured to store an executable instruction of the processor; where
the processor, when running the executable instruction, is configured to implement the information transmission method of any embodiment of the present disclosure.

In an embodiment, the communication device may include, but is not limited to, at least one of the following: a UE and a network device. The network device here may include a core network or an access network function, etc. Here, the access network function may include a base station. The core network may include an AMF, an SMF.

In some embodiments, the processor may include various types of storage media, where the storage media are non-transitory computer storage media capable of continuing to memorize information stored thereon after the UE is powered down.

The processor may be connected to the memory via a bus or the like for reading an executable program stored in the memory, for example, at least one of the methods shown in FIGS. 2 to 9.

The embodiments of the present disclosure also provide a computer storage medium. The computer storage medium stores an executable program of a computer. The executable program, when executed by a processor, implements the information transmission method of any embodiment of the present disclosure, for example, at least one of the methods shown in FIGS. 2 to 9.

With respect to the device or storage medium in the above embodiments, the specific manner in which each module performs an operation has been described in detail in the embodiments relating to the method, and will not be described in detail here.

FIG. 16 is a block diagram of a UE 3000 according to an exemplary embodiment. For example, the UE 3000 may be a mobile phone, a computer, a digital broadcast user equipment, a message transceiver device, a game console, a tablet device, a medical device, a fitness device, or a personal digital assistant.

Referring to FIG. 16, the UE 3000 may include one or more of the following components: a processing component 3002, a memory 3004, a power supply component 3006, a multimedia component 3008, an audio component 3010, an input/output (I/O) interface 3012, a sensor component 3014, and a communication component 3016.

The processing component 3002 generally controls the overall operation of the UE 3000, such as operations associated with display, telephone calls, data communication, camera operations, and recording operations. The processing component 3002 may include one or more processors 3020 to execute an instruction to complete all or part of the steps of the method described above. In addition, the processing component 3002 may include one or more modules that facilitate interaction between the processing component 3002 and other components. For example, the processing component 3002 may include a multimedia module to facilitate interaction between the multimedia component 3008 and the processing component 3002.

The memory 3004 is configured to store various types of data to support the operations on the UE 3000. Examples of such data include the following: an instruction of any application program or method operated on the UE 3000, contact data, phonebook data, messages, pictures, videos, etc. The memory 3004 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or a CD-ROM.

The power supply component 3006 supplies power to various components of the UE 3000. The power supply component 3006 may include a power supply management system, one or more power supplies, and other components associated with generating, managing and distributing power for the UE 3000.

The multimedia component 3008 includes a screen that provides an output interface between the UE 3000 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of the touch or swipe action, but also detect the duration and pressure associated with the touch or swipe operation. In some embodiments, the multimedia component 3008 includes a front-facing camera and/or a rear-facing camera. The front-facing camera and/or the rear-facing camera may receive external multimedia data when the UE 3000 is in an operating mode, such as a shooting mode or a video mode. Each of the front-facing camera and the rear-facing camera may be a fixed optical lens system or have a focal length and optical zoom capability.

The audio component 3010 is configured to output and/or input audio signals. For example, the audio component 3010 includes a microphone (MIC), configured to receive external audio signals when the UE 3000 is in an operating mode, such as a calling mode, a recording mode and a voice recognition mode. The received audio signals may be further stored in the memory 3004 or sent via the communication component 3016. In some embodiments, the audio component 3010 further includes a speaker for outputting the audio signals.

The I/O interface 3012 provides an interface between the processing component 3002 and a peripheral interface module, and the peripheral interface module may be a keypad, a click wheel, a button, etc. These buttons may include, but are not limited to, a home button, a volume button, a start button, and a lock button.

The sensor component 3014 includes one or more sensors configured to provide status assessment of various aspects of the UE 3000. For example, the sensor component 3014 may detect an open/closed state of the device 3000, relative positioning of the components, for example, the components are the display and small keypad of the UE 3000. The sensor component 3014 may also detect a change in the position of the UE 3000 or a change in the position of one component of the UE 3000, the presence or absence of contact between the user and the UE 3000, the orientation or acceleration/deceleration of UE 3000, and temperature changes of the UE 3000. The sensor component 3014 may include a proximity sensor that is configured to detect the presence of nearby objects in the absence of any physical contact. The sensor component 3014 may also include a light sensor, such as a CMOS or CCD image sensor, for use in imaging applications. In some embodiments, the sensor component 3014 may also include an accelerometer sensor, a gyroscope sensor, a magnetic sensor, a pressure sensor, or a temperature sensor.

The communication component 3016 is configured to facilitate the communication between the UE 3000 and other devices by wired or wireless means. The UE 3000 may access a wireless network based on a communication standard, such as WiFi, 4G, 5G, or a combination thereof. In an exemplary embodiment, the communication component 3016 receives broadcast signals or broadcast related information from an external broadcast management system via a broadcast channel. In an exemplary embodiment, the communication component 3016 further includes a near-field communication (NFC) module to facilitate short-range communication. For example, the NFC module may be implemented based on the radio frequency identification (RFID) technology, the infrared data association (IrDA) technology, the ultra-wideband (UWB) technology, the bluetooth (BT) technology, or other technologies.

In an exemplary embodiment, the UE 3000 may be implemented by one or more of the following: an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic elements, to perform the methods described above.

In an exemplary embodiment, a non-transitory computer-readable storage medium including an instruction is provided, such as the memory 3004 including an instruction. The instruction described above is capable of being executed by the processor 3020 of the UE 3000 to complete the methods described above. For example, the non-transitory computer-readable storage medium may be an ROM, a random access memory (RAM), a CD-ROM, a magnetic tape, a floppy disk, or an optical data storage device.

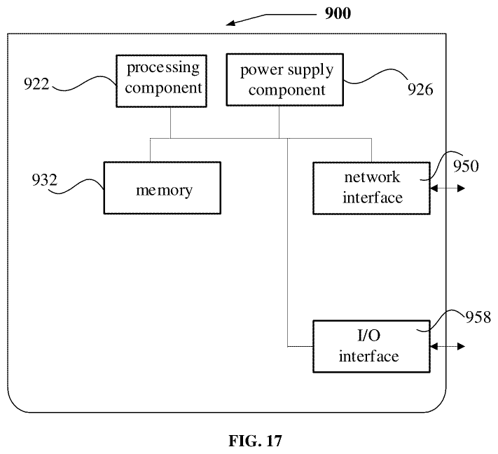

As shown in FIG. 17, an embodiment of the present disclosure illustrates a structure of a base station. For example, the base station 900 may be provided as a network side device. Referring to FIG. 17, the base station 900 includes a processing component 922, where the processing component 922 further includes one or more processors, and a memory resource represented by a memory 932 for storing an instruction, such as an application program, that is executable by the processing component 922. The application program stored in the memory 932 may include one or more modules each corresponding to a set of instructions. In addition, the processing component 922 is configured to execute the instruction to perform any method described above applied to the base station.

The base station 900 may further include a power supply component 926 configured to perform power management of the base station 900, a wired or wireless network interface 950 configured to connect the base station 900 to the network, and an I/O interface 958. The base station 900 may operate an operating system stored in the memory 932, such as Windows Server™, Mac OS X™, Unix™, Linux™, FreeBSD™, or the like.

After considering the specification and practicing the invention disclosed herein, those skilled in the art will easily come up with other implementation solutions of the present invention. The present disclosure is intended to cover any variations, uses or adaptive changes of the present invention, and the variations, uses or adaptive changes follow the general principles of the present invention and include common knowledge or commonly used technical means in the technical field that is not disclosed in the present disclosure. The specification and embodiments are only considered to be exemplary, and the true scope and spirit of the present invention are indicated by the following claims.

It should be understood that the present invention is not limited to the precise structure which has been described above and illustrated in the accompanying drawings, and that various modifications and alterations may be made without departing from the scope of the present invention. The scope of the present invention is limited only by the appended claims.

1. An information transmission method, performed by a session management function (SMF), comprising:
sending UE status information of a user equipment (UE) to an access network function, wherein the UE status information is used for the access network function to determine at least one of a service data stream transmission of the UE, or a quality of service (QoS) parameter of the service data stream transmission.

2. The method according to claim 1, further comprising at least one of:
receiving the UE status information sent by the UE;
receiving the UE status information from a unified data management (UDM); or
receiving the UE status information from a policy control function (PCF).

3. The method according to claim 2, wherein the receiving the UE status information sent by the UE comprises:
receiving a session management (SM) context establishment request sent by an access and mobility management function (AMF) to the SMF, wherein the SM context establishment request carries the UE status information, and the SM context establishment request is sent by the AMF upon receiving a packet data unit (PDU) session establishment request carrying the UE status information.

4. The method according to claim 3, wherein the UE status information is carried in at least one of:
a protocol configuration option (PCO) in the PDU session establishment request; or
UE session management core network capability information in the PDU session establishment request.

5. The method according to claim 2, wherein the receiving the UE status information from the UDM comprises:
receiving, from the UDM, an expected UE behaviour parameter carrying the UE status information.

6. The method according to claim 2, wherein the receiving the UE status information from the UDM comprises:
receiving, from the UDM, the UE status information of an SMF related parameter stored by the UDM.

7. The method according to claim 2, wherein the UE status information from the UDM is subscribed by the SMF to the UDM.

8. The method according to claim 1, further comprising:
sending the UE status information to a PCF, wherein the UE status information is used for the PCF to determine at least one of a non-session policy or a session policy associated with the UE.

9. The method according to claim 1, wherein the sending the UE status information of the UE to the access network function comprises:
sending an N2 session message carrying the UE status information to an AMF, wherein the UE status information is sent to the access network function by the AMF through carrying the UE status information in at least one of an N2 message or a next generation application protocol (NGAP) signaling.

10. The method according to claim 1, wherein the UE status information is at least used for indicating at least one of:
a battery power of the UE;
a battery usage duration of the UE;
a power supply mode of the UE; or
a temperature status of the UE.

11. The method according to claim 1, wherein the service data stream of the UE comprises at least one of:
an extended reality (XR) type service data stream of the UE; or
a multimodal data service data stream of the UE.

12. An information transmission method, performed by a unified data management (UDM), comprising:
sending UE status information of a user equipment (UE) to a session management function (SMF), wherein the UE status information is used for being sent by the SMF to an access network function for the access network function to determine at least one of a service data stream transmission of the UE or a quality of service (QoS) parameter of the service data stream transmission.

13. The method according to claim 12, further comprising:
receiving the UE status information from a network exposure function (NEF), wherein the UE status information is received by an application function (AF) from the UE and sent by the AF to the NEF.

14. The method according to claim 13, further comprising:
storing the UE status information as an SMF related parameter.

15. The method according to claim 13, wherein the receiving the UE status information from the NEF comprises:
receiving, from the NEF, an expected UE behaviour parameter carrying the UE status information; or
obtaining subscription information from a unified data repository (UDR); and
receiving, in response to the subscription information indicating permission to store the UE status information, the UE status information from the NEF.

16. The method according to claim 15, wherein the sending the UE status information to the SMF comprises:
sending, to the SMF, the expected UE behaviour parameter carrying the UE status information.

17.-21. (canceled)

22. An information transmission method, performed by an access network function, comprising:
receiving UE status information of a user equipment (UE) sent by a core network, wherein the UE status information is used for the access network function to determine at least one of a service data stream transmission of the UE, or a quality of service (QoS) parameter of the service data stream transmission.

23. The method according to claim 22, wherein the receiving the UE status information of the UE sent by the core network comprises:
receiving the UE status information from a session management function (SMF) of the core network.

24.-46. (canceled)

47. A communication device, comprising:
a processor; and
a memory, configured to store an executable instruction of the processor; wherein
the processor, when running the executable instruction, is configured to implement the information transmission method according to claim 1.

48. A non-transitory computer storage medium, wherein the computer storage medium stores an executable program of a computer, and the executable program, when executed by a processor, implements the information transmission method according to claim 1.
